(19) United States
(12) Patent Application Publication
(10) Pub. No.: US 2025/0166146 A1
(43) Pub. Date: May 22, 2025

(54) IMAGE PROCESSING APPARATUS, IMAGE PROCESSING METHOD, AND PROGRAM

(71) Applicant: SONY GROUP CORPORATION, TOKYO (JP)

(72) Inventor: HIROKAZU YASUI, TOKYO (JP)

(21) Appl. No.: 18/841,635

(22) PCT Filed: Feb. 3, 2023
(86) PCT No.: PCT/JP2023/003592

§ 371 Date: Aug. 26, 2024

(30) Foreign Application Priority Data
Mar. 4, 2022 (JP) 2022-033379

(51) Int. Cl. G06T 5/94; G06V 10/44; G06V 10/60

(52) U.S. Cl. CPC G06T 5/94; G06V 10/44; G06V 10/60; G06T 2207/20192

(57) ABSTRACT

To improve image quality of an image obtained by capturing a dark portion while improving ease of in-focus confirmation. An image processing apparatus according to the present technology including: a contrast extraction unit that obtains a contrast image by extracting a contrast component from an input image based on a captured image; an edge extraction unit that obtains an edge image by extracting an edge component from the input image; an edge-enhancement processing unit that obtains an edge-enhanced contrast image by performing processing of multiplying the contrast image by a coefficient determined according to a signal value of the edge image; an image amplification unit that obtains an amplified image by amplifying the input image; and a superimposed image generation unit that obtains a superimposed image obtained by superimposing the edge-enhanced contrast image on the amplified image.

### TECHNICAL FIELD

The present technology relates to an image processing apparatus, an image processing method, and a program, and particularly relates to a technical field related to enhancement of an edge and contrast in an image.

### BACKGROUND ART

High dynamic range (HDR) imaging can express an image with a wide dynamic range, and can express a dark portion, a color with high luminance, and the like, which cannot be fully expressed by a standard dynamic range (SDR) image with a standard dynamic range that can be displayed on a normal display device.

Here, in an imaging system that realizes HDR imaging, a SDR-compatible display device is generally used as a display device such as a view finder (VF) that displays a through-the-lens image of a camera, that is, an image for allowing a user to confirm an image being captured, instead of an HDR-compatible display device. Therefore, in an imaging system that implements HDR imaging, a system that generates an SDR image is generally provided together with a system that generates an HDR image.

The SDR image is generated by performing signal compression by, for example, knee (KNEE) processing or the like on a high-luminance image region in the captured image, and a data amount is reduced with respect to the HDR image. However, in the SDR image, since the contrast of the high-luminance image region is minute as compared with the HDR image, there is the problem that the reproducibility of the high-luminance image region is deteriorated.

To solve this problem, Patent Document 1 below extracts a contrast component (a component indicating a degree of change in luminance) of a high-luminance image region from an image before a signal of the high-luminance image region is compressed, and superimposes the contrast component on an SDR image, thereby improving reproducibility of the high-luminance image region in the SDR image.

Furthermore, the captured image may include a low-luminance image region in addition to the high-luminance image region. Since the SDR image has a narrower dynamic range than the HDR image, the reproducibility (visibility) of the low-luminance image region also tends to decrease, and improvement thereof is desired.

In the following Patent Document 2, a contrast component of the low-luminance image region is extracted from an image before SDR conversion (before knee processing), the contrast component is superimposed on an amplified image (gain-up image) of the image before SDR conversion, and the amplified image on which the contrast component is superimposed in this manner is superimposed on the SDR image, thereby improving visibility of the low-luminance image region in the SDR image.

Here, for example, in a case where a dark portion is captured, such as a case where capturing is performed outdoors at night or indoors with little illumination light, it is considered that a user manually performs focus adjustment of a camera on the basis of a through-the-lens image.

When the through-the-lens image is displayed as the SDR image, the visibility in the low-luminance image region tends to be low as described above, and thus it is difficult for the user to perform an in-focus confirmation (confirmation as to whether or not the subject is in focus).

Although it is conceivable to apply the technique of improving the visibility of the low-luminance image region according to Patent Document 2 described above, in the low-luminance image region, the original signal value is small, and the signal value difference between the in-focus state and the out-of-focus state tends to be small, so that it is difficult to perform the in-focus confirmation.

As a technique for improving ease of the in-focus confirmation, Patent Document 3 below can be mentioned. Specifically, Patent Document 3 discloses a technique of adding (superimposing) a signal (contour correction signal: edge signal) obtained by extracting a high frequency component from an imaging signal to the imaging signal.

### CITATION LIST

### Patent Document

Patent Document 1: WO 2018/169003 A
Patent Document 2: WO 2022/004518 A
Patent Document 3: Japanese Patent Application Laid-Open No. 2001-136419

### SUMMARY OF THE INVENTION

### Problems to Be Solved by the Invention

However, according to the technique described in Patent Document 3 described above, noise amplified with an amplification factor similar to that of the edge portion is also superimposed on the imaging signal, and thus image quality degradation of the through-the-lens image becomes a problem.

The present technology has been made in view of the above-described circumstances, and an object of the present technology is to achieve image quality improvement while achieving easiness improvement of in-focus confirmation for an image obtained by capturing a dark portion.

### Solutions to Problems

An image processing apparatus according to the present technology includes: a contrast extraction unit that obtains a contrast image by extracting a contrast component from an input image based on a captured image; an edge extraction unit that obtains an edge image by extracting an edge component from the input image; an edge-enhancement processing unit that obtains an edge-enhanced contrast image by performing processing of multiplying the contrast image by a coefficient determined according to a signal value of the edge image; an image amplification unit that obtains an amplified image by amplifying the input image; and a superimposed image generation unit that obtains a superimposed image obtained by superimposing the edge-enhanced contrast image on the amplified image.

In the edge image, the signal value increases as approaching the in-focus state. Therefore, in the superimposed image in which the edge-enhanced contrast image obtained on the basis of the edge image is superimposed on the amplified image of the input image as described above, the edge portion is enhanced as approaching the in-focus state, and it is possible to improve the easiness of the in-focus confirmation by using the superimposed image as the corrected image for the output target image such as the through-the-lens image or the like. Then, since the edge-enhanced contrast image is generated by multiplying the contrast image by a coefficient determined according to the signal value of the edge image, it is possible to prevent the signal value amplification of the contrast image from being performed for a portion having a small signal value in the edge image, that is, a portion regarded as noise. Therefore, it is possible to prevent a noise component from being superimposed on the superimposed image. Furthermore, according to the above-described configuration, since the contrast component extracted from the input image can be superimposed on the output target image, it is possible to improve the reproducibility of the low-luminance image region in the case of capturing the dark portion.

Furthermore, an image processing method according to the present technology is an image processing method in which a signal processing apparatus performs processing of obtaining a contrast image obtained by extracting a contrast component from an input image based on a captured image and an edge image obtained by extracting an edge component from the input image, performing processing of multiplying the contrast image by a coefficient determined according to a signal value of the edge image to obtain an edge-enhanced contrast image, and obtaining a superimposed image obtained by superimposing the edge-enhanced contrast image on an amplified image of the input image.

Moreover, a program according to the present technology is a program that can be read by a computer device, and causes the computer device to execute processing of: obtaining a contrast image obtained by extracting a contrast component from an input image based on a captured image and an edge image obtained by extracting an edge component from the input image; multiplying the contrast image by a coefficient determined according to a signal value of the edge image to obtain an edge-enhanced contrast image; and obtaining a superimposed image obtained by superimposing the edge-enhanced contrast image on an amplified image of the input image.

With such image processing method and program, it is possible to implement the image processing apparatus according to the present technology described above.

### BRIEF DESCRIPTION OF DRAWINGS

FIG. 1 is a block diagram illustrating a schematic configuration example of an imaging system including an image processing apparatus according to an embodiment of the present technology.

FIG. 2 is a block diagram for describing an internal configuration example of the image processing apparatus as a first embodiment.

FIG. 3 is a diagram for describing an internal configuration example of an HDR processing unit and an SDR processing unit according to an embodiment.

FIG. 4 is a graph showing a relationship between first and second cutoff frequencies and frequency bands of a contrast image and an edge image.

FIG. 5 is a graph showing an example of an original signal value in each pixel.

FIG. 6 is a graph illustrating an example of a contrast signal value in each pixel.

FIG. 7 is a graph showing an example of an edge signal value in each pixel.

FIG. 8 is a graph for describing a setting example of a gain value based on an edge signal value.

FIG. 9 is a graph showing an example of a gain value calculated from the edge signal value in each pixel.

FIG. 10 is a graph showing a comparison result with only contrast image superimposition.

FIG. 11 is a graph showing a comparison result with only edge image superimposition.

FIG. 12 is a graph showing each comparison result with in-focus state and with the out-of-focus state.

FIG. 13 is a flowchart illustrating a specific processing procedure example for realizing correction processing as an embodiment.

FIG. 14 is a diagram for describing a configuration example of an image processing apparatus as a second embodiment.

FIG. 15 is an explanatory diagram of generation patterns of a low-luminance image region and a high-luminance image region in an input image.

FIG. 16 is a diagram for describing an example of an operation of changing a frequency band to be extracted.

FIG. 17 is a diagram for describing another example of an operation of changing a frequency band to be extracted.

FIG. 18 is a diagram for describing a configuration example of an image processing apparatus as a third embodiment.

FIG. 19 is an explanatory diagram of a first modification.

FIG. 20 is an explanatory diagram of a second modification.

FIG. 21 is an explanatory diagram of a third modification.

FIG. 22 is an explanatory diagram of a fourth modification.

FIG. 23 is an explanatory diagram of a fifth modification.

FIG. 24 is an explanatory diagram of a sixth modification.

### MODE FOR CARRYING OUT THE INVENTION

Hereinafter, embodiments according to the present technology will be described in the following order with reference to the accompanying drawings.
<1. First Embodiment>
(1-1. Overview of Configuration of Imaging System>
(1-2. Internal Configuration of Imaging Device)
(1-3. Correction Processing Unit)
(1-4. Processing Procedure)
<2. Second Embodiment>
<3. Third Embodiment>
<4. Modification>
<5. Summary of Embodiments>
<6. Present Technology>

### 1. First Embodiment

### 1-1. Overview of Configuration of Imaging System

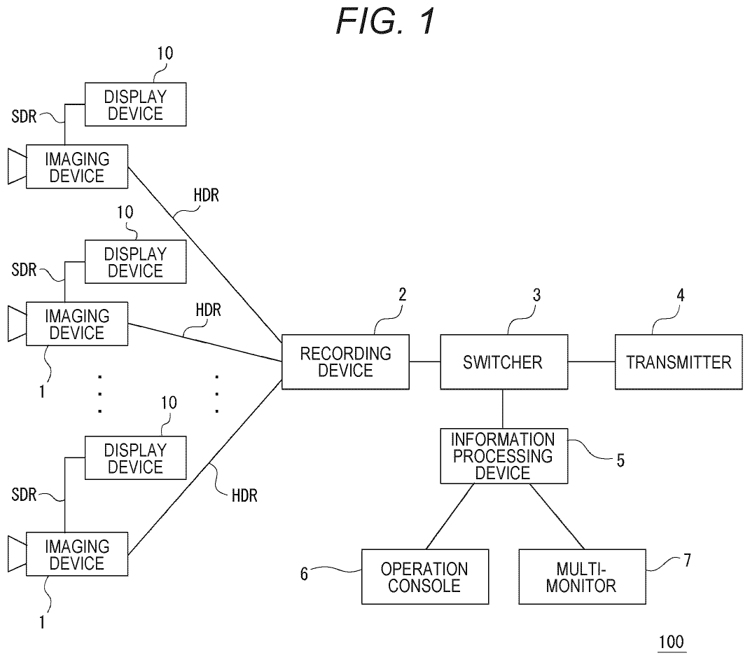

FIG. 1 is a block diagram illustrating a schematic configuration example of an imaging system 100 including an image processing apparatus according to an embodiment of the present technology.

The imaging system 100 is configured as a broadcasting system having a function of transmitting an image selected by an operator from among images captured by a plurality of cameras (imaging devices) for broadcasting.

As illustrated, the imaging system 100 includes a plurality of imaging devices 1, a recording device 2, a switcher 3, a transmitter 4, an information processing device 5, an operation console 6, a multi-monitor 7, and a plurality of display devices 10. Among these configuration elements, the imaging device 1 is an embodiment of an image processing apparatus according to the present technology.

The imaging device 1 includes, for example, an imaging element of a complementary metal oxide semiconductor (CMOS) type, a charge coupled device (CCD) type, and the like, obtains a captured image obtained by capturing a subject, and outputs the captured image to the recording device 2. In the present example, the imaging device 1 outputs a captured image in the form of moving image data.

The display device 10 is configured as a display device that can display an image, such as a liquid crystal display (LCD), an organic electro-luminescence (EL) display, and the like, and is provided to display an image captured by the imaging device 1. Specifically, in the present example, the display device 10 is a display device as a view finder (VF) for displaying an image captured by the imaging device 1 as a through-the-lens image.

The through-the-lens image mentioned here means an image for allowing a user to confirm an image being captured.

In the present example, the display device 10 is provided for each imaging device 1.

Note that the device form of the display device 10 is not limited to the VF form, and may be an external monitor or the like provided separately from the imaging device 1.

In the present embodiment, the imaging device 1 generates and outputs an image in a high dynamic range (HDR) video format as a captured image to be output to the recording device 2. On the other hand, the imaging device 1 generates and outputs an image in a standard dynamic range (SDR) video format for a through-the-lens image to be displayed on the display device 10.

Here, the HDR image is an image having a wider dynamic range than the SDR image. For example, the HDR image is an image having a dynamic range equal to or larger than 10 times of the dynamic range of the SDR image.

In the present example, the HDR image is generated as an image having a higher resolution than the SDR image. Specifically, the resolution of the HDR image is, for example, 4k or 8k resolution, and the resolution of the SDR image is, for example, full high definition (FHD) or less resolution.

Note that the specific numerical values of the resolutions of the HDR image and the SDR image are not limited thereto, and moreover, the magnitude relationship between the resolutions of the HDR image and the SDR image is not limited to the example described above.

The recording device 2 includes a storage device such as a hard disk drive (HDD) or a flash memory device, for example, and records a captured image as moving image data output from each imaging device 1 and outputs the captured image to the switcher 3. Furthermore, the recording device 2 can also add a video effect such as a replay to the captured image as recorded moving image data on the basis of an operation input and output the captured image to the switcher 3.

The switcher 3 selects a captured image to be output to the transmitter 4 from among captured images from the respective imaging devices 1 input via the recording device 2 on the basis of an instruction from the information processing device 5.

The transmitter 4 transmits the captured image selected by the switcher 3 as a broadcast image.

The information processing device 5 is configured as a computer device including a central processing unit (CPU).

The captured image output from the recording device 2 is input to the information processing device 5 via the switcher 3. The information processing device 5 is connected to the operation console 6 provided with various operation elements used for operation by a user as an operator and a display device as the multi-monitor 7, and the information processing device 5 displays each captured image input to the switcher 3 on the multi-monitor 7 and instructs the switcher 3 on the captured image to be output to the transmitter 4 on the basis of the operation input of the user via the operation console 6.

Note that the multi-monitor 7 may be a single display device, or may include a plurality of display devices that individually displays captured images.

### 1-2. Internal Configuration of Imaging Device

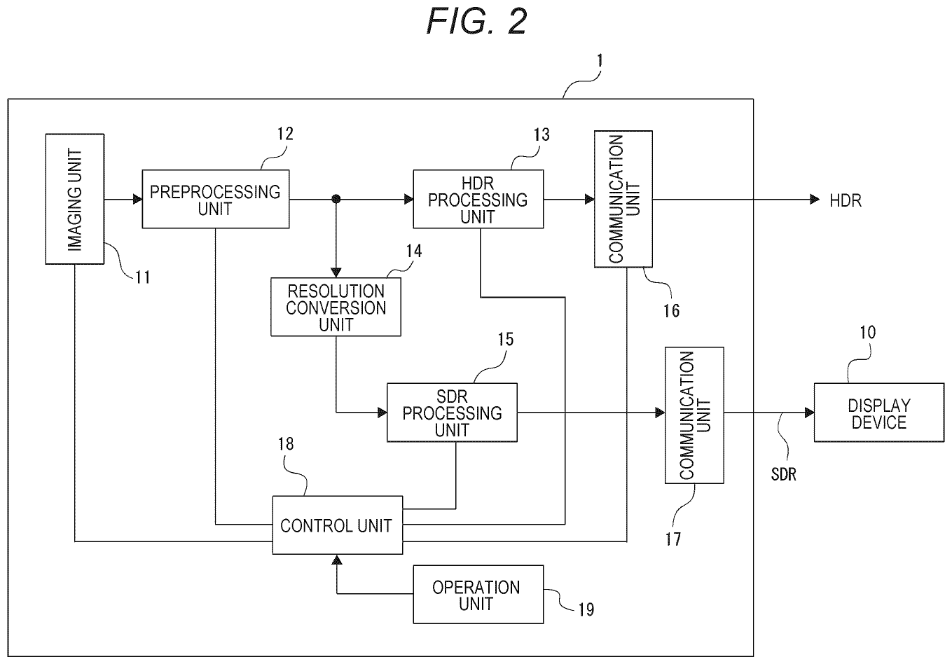

FIG. 2 is a block diagram for describing an internal configuration example of the imaging device 1. Note that FIG. 2 illustrates the display device 10 illustrated in FIG. 1 together with the internal configuration example of the imaging device 1.

As illustrated, the imaging device 1 includes an imaging unit 11, a preprocessing unit 12, an HDR processing unit 13, a resolution conversion unit 14, an SDR processing unit 15, a communication unit 16, a communication unit 17, a control unit 18, and an operation unit 19.

The imaging unit 11 includes an optical system including lenses such as a cover lens, a zoom lens, and a focus lens, a shutter, a diaphragm mechanism, and the like, and an imaging element such as a CMOS type, a CCD type, and the like that receives light from a subject incident through the optical system.

Note that the lens may be an interchangeable lens system.

The imaging unit 11 performs, for example, correlated double sampling (CDS) processing, automatic gain control (AGC) processing, and the like on an electric signal obtained by photoelectrically converting light received by the imaging element, and further performs analog/digital (A/D) conversion processing. Then, a captured image signal (hereinafter also referred to as “captured image data”) as digital data is output to the preprocessing unit 12 in the subsequent stage.

In the present example, the imaging unit 11 includes three imaging elements, that is, an imaging element for R that selectively receives red (R) light, an imaging element for G that selectively receives green (G) light, and an imaging element for B that selectively receives blue (B) light. That is, the imaging unit 11 in this case obtains three pieces of captured image data, that is, captured image data as an R image obtained by selectively receiving R light, captured image data as a G image obtained by selectively receiving G light, and captured image data as a B image obtained by selectively receiving B light, as the captured image data, and outputs the three pieces of captured image data to the preprocessing unit 12. Therefore, in the subsequent stage processing of the imaging unit 11 in the present example, color interpolation processing (color interpolation processing for obtaining each of R, G, and B signals for each pixel) such as demosaic processing or the like is not performed on the input captured image data.

Note that the configuration of the imaging unit 11 in the three-plate type of R, G, and B as described above is merely an example, and it is of course possible to adopt a single-plate type configuration using a single imaging element in which R, G, and B pixels are arranged in a predetermined pattern, such as a Bayer array, or the like. In that case, color interpolation processing such as demosaic processing and the like is performed in the subsequent stage processing.

The preprocessing unit 12 performs predetermined image signal processing of various correction processing and the like such as defect correction and lens aberration correction on the input captured image (captured image data).

The captured image processed by the preprocessing unit 12 is input to the HDR processing unit 13 and also input to the SDR processing unit 15 via the resolution conversion unit 14.

The HDR processing unit 13 performs processing for generating moving image data in the HDR video format as moving image data based on the captured image. The SDR processing unit 15 performs processing for generating moving image data in the SDR video format as moving image data based on the captured image.

As described above, in the present example, since the SDR image is an image having a lower resolution than the HDR image, the captured image whose resolution has been converted (whose resolution has been reduced) by the resolution conversion unit 14 is input to the SDR processing unit 15.

Note that internal configurations of the HDR processing unit 13 and the SDR processing unit 15 will be described again.

The moving image data in the HDR video format obtained by the HDR processing unit 13 is output to an external device, specifically, the recording device 2 in the present example, via the communication unit 16.

Here, the communication unit 16 performs wired or wireless data communication with the external device. As the communication unit 16, for example, a unit that performs data communication via a predetermined network such as the Internet or a local area network (LAN) and the like can be used.

Furthermore, the moving image data in the SDR video format obtained by the SDR processing unit 15 is output to the display device 10 via the communication unit 17. The communication unit 17 performs wired or wireless data communication with the external device.

Note that the SDR image can be transmitted to a device other than the display device 10, such as a camera control unit (CCU) or the like, through a camera cable, for example.

The control unit 18 includes a microcomputer (arithmetic processing unit) including a CPU, a read only memory (ROM), a random access memory (RAM), and the like. The ROM of the control unit 18 stores an operating system (OS) for the CPU to control each unit, an application program for various operations, firmware, and the like. The RAM of the control unit 18 is used for temporary storage of data, programs, and the like as a work area at the time of various types of data processing of the CPU.

The operation unit 19 is connected to the control unit 18.

The operation unit 19 collectively represents input devices for the user to perform various operation inputs, and includes, for example, various operation elements (keys, dials, touch panels, touch pads, and the like) provided in the housing of the imaging device 1.

The operation of the user is detected by the operation unit 19, and a signal corresponding to the input operation is transmitted to the control unit 18.

The control unit 18 performs overall control of the imaging device 1 by the CPU executing a program stored in the ROM or the like. For example, the control unit 18 performs operation control of the imaging unit 11 such as setting operation of a shutter speed and a diaphragm, and operation control such as an instruction to execute or stop processing on the preprocessing unit 12, the HDR processing unit 13, and the SDR processing unit 15, and the like. Furthermore, the control unit 18 controls the operation of each necessary unit with respect to the imaging operation, the user interface operation, and the like according to the operation of the user.

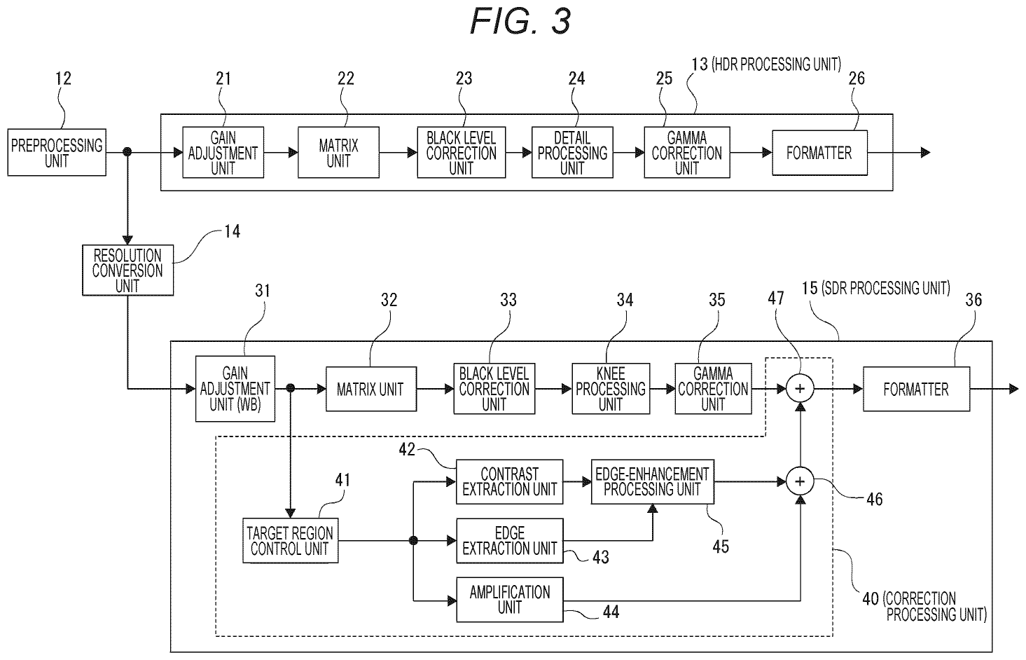

FIG. 3 is a diagram for describing an internal configuration example of the HDR processing unit 13 and the SDR processing unit 15. Note that FIG. 3 illustrates the preprocessing unit 12 and the resolution conversion unit 14 illustrated in FIG. 2 together with an internal configuration example of the HDR processing unit 13 and the SDR processing unit 15.

As illustrated, the HDR processing unit 13 includes a gain adjustment unit 21, a matrix unit 22, a black level correction unit 23, a detail processing unit 24, a gamma correction unit 25, and a formatter 26.

The gain adjustment unit 21 inputs the captured image processed by the preprocessing unit 12, and performs gain adjustment processing of RGB gain adjustment or the like for white balance adjustment.

The matrix unit 22 performs linear matrix processing on the captured image processed by the gain adjustment unit 21, and the black level correction unit 23 performs processing of clamping the black levels of R, G, and B to a predetermined level on the captured image processed by the matrix unit 22.

The detail processing unit 24 inputs the captured image processed by the black level correction unit 23 and performs detail processing, and the gamma correction unit 25 inputs the captured image processed by the detail processing unit 24 and performs gamma correction processing.

The formatter 26 inputs the captured image processed by the gamma correction unit 25, and performs format processing for obtaining moving image data in the HDR video format as moving image data based on the captured image. In this format processing, for example, processing of converting RGB 444 into RGB 444, YC 444, YC 422, and the like is performed.

The moving image data in the HDR video format obtained by the formatter 26 is output to an external device of the recording device 2 or the like via the communication unit 16.

The SDR processing unit 15 includes a gain adjustment unit 31, a matrix unit 32, a black level correction unit 33, a knee (KNEE) processing unit 34, a gamma correction unit 35, a formatter 36, and a correction processing unit 40.

The gain adjustment unit 31 inputs the captured image after the resolution conversion input from the preprocessing unit 12 via the resolution conversion unit 14, and performs gain adjustment processing such as RGB gain adjustment for white balance adjustment.

The matrix unit 32 performs linear matrix processing on the captured image processed by the gain adjustment unit 31, and the black level correction unit 33 performs processing of clamping the black levels of R, G, and B to a predetermined level on the captured image processed by the matrix unit 32.

A knee processing unit 34 receives an input of the captured image processed by the black level correction unit 33, and performs knee processing of correcting a luminance value of a pixel whose luminance value is equal to or larger than a predetermined value (knee correction point), thereby generating an SDR image whose dynamic range is narrower than that of the HDR image.

Here, the knee processing means processing of compressing a signal of a portion having high luminance so as to fall within the dynamic range in order to prevent blown-out highlights in the SDR image.

The gamma correction unit 35 performs gamma correction processing on the captured image as the SDR image obtained by the knee processing unit 34.

The captured image as the SDR image processed by the gamma correction unit 35 is input to the formatter 36 via the correction processing unit 40.

The formatter 36 performs format processing for obtaining moving image data in the SDR video format for the captured image input via the correction processing unit 40.

The moving image data in the SDR video format obtained by the formatter 36 is output to the display device 10 via the communication unit 17.

The correction processing unit 40 generates a corrected image for achieving both the easiness improvement of in-focus confirmation and the image quality improvement for a low-luminance image region in the SDR image, and corrects the SDR image on the basis of the corrected image.

### 1-3. Correction Processing Unit

The correction processing unit 40 for obtaining the corrected image as described above will be described.

As illustrated in FIG. 3, the correction processing unit 40 includes a target region control unit 41, a contrast extraction unit 42, an edge extraction unit 43, an amplification unit 44, an edge-enhancement processing unit 45, an addition unit 46, and an addition unit 47.

The target region control unit 41 controls an image region to be corrected by the corrected image. Specifically, the target region control unit 41 detects a low-luminance image region that is a region having a luminance value less than a first threshold value in the input captured image, and outputs the luminance value of the low-luminance image region (the luminance value of each pixel in the low-luminance image region) to the contrast extraction unit 42, the edge extraction unit 43, and the amplification unit 44.

Contrast extraction unit 42 obtains a contrast image by extracting a contrast component of the low-luminance image region on the basis of the luminance value of the low-luminance image region input from the target region control unit 41.

Furthermore, the edge extraction unit 43 obtains an edge image by extracting an edge component of the low-luminance image region on the basis of the luminance value of the low-luminance image region input from the target region control unit 41.

Here, the contrast component in the present specification means a frequency component including not only an edge component but also a portion having a relatively flat contrast such as a texture component among frequency components included in a target image.

In the present embodiment, each of the contrast extraction unit 42 and the edge extraction unit 43 includes a high-pass filter (HPF), the contrast extraction unit 42 extracts a frequency component of the input image by a first cutoff frequency fc1, and the edge extraction unit 43 extracts a frequency component of the input image by a second cutoff frequency fc2 higher than the first cutoff frequency fc1.

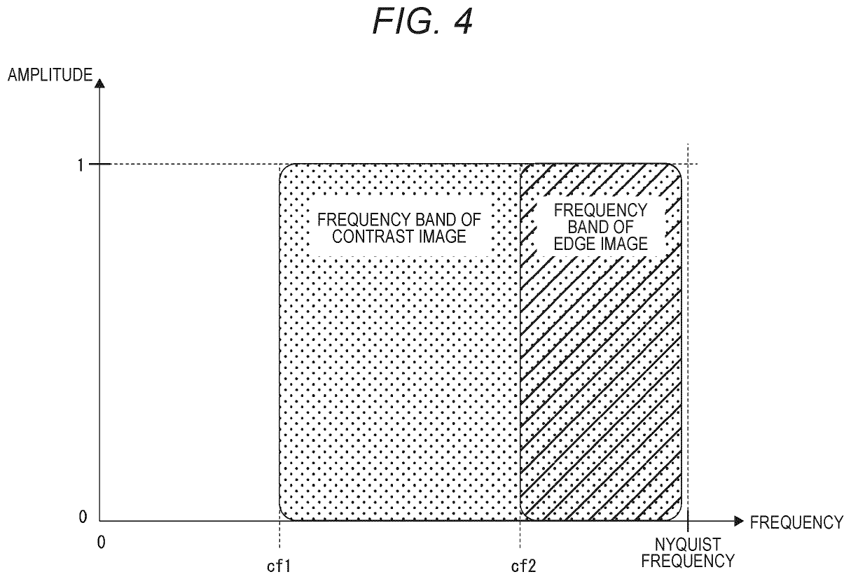

For confirmation, FIG. 4 illustrates a relationship between the first cutoff frequency fc1 and the second cutoff frequency fc2 and the frequency band of the contrast image and the frequency band of the edge image. In the drawing, dot indicates a frequency band of a contrast image, and hatching indicates a frequency band of an edge image. In the present example, the frequency band of the contrast image is a frequency band including the highest frequency lower than the Nyquist frequency and including a frequency higher than the first cutoff frequency fc1. The frequency band of the edge image is a frequency band including the highest frequency described above and including a frequency higher than the second cutoff frequency fc2.

With the frequency setting as described above, the contrast image can be said to be an image obtained by extracting a high-frequency side component of the target image in a wider frequency band than the edge image. Therefore, in the contrast image, not only the edge component of the subject but also the component of the flat portion such as the texture can be extracted.

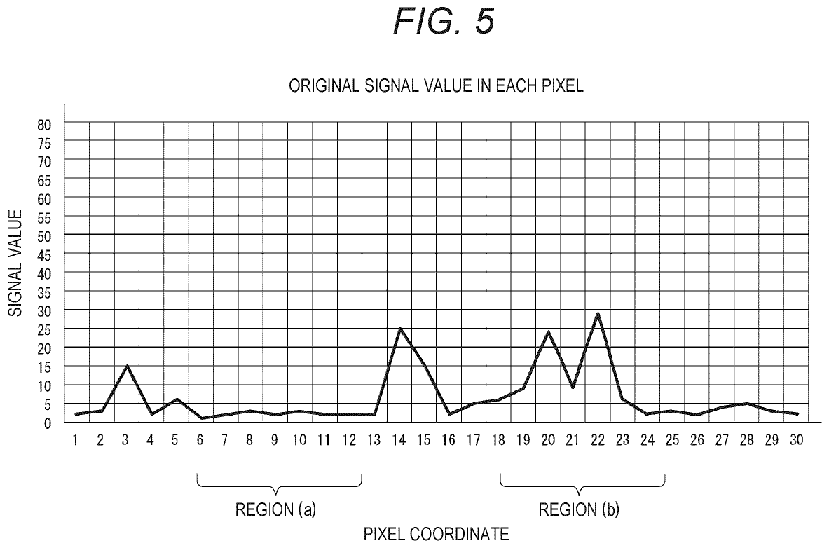

An example of the signal value of the contrast image and the signal value of the edge image will be described with reference to FIGS. 5 to 7.

FIG. 5 illustrates an example of an original signal value in each pixel. The original signal value mentioned here means a signal value of an original image that is an image from which the correction processing unit 40 generates a corrected image. Specifically, in the present example, the original signal value means a signal value (luminance value) of a captured image input from the gain adjustment unit 31 to the correction processing unit 40.

FIG. 5 illustrates an example of the original signal value of each pixel in a certain row of the captured image. In the example of FIG. 5, a region (a) in the graph is a region as a flat portion including texture and noise, and a region (b) is a region of an edge portion.

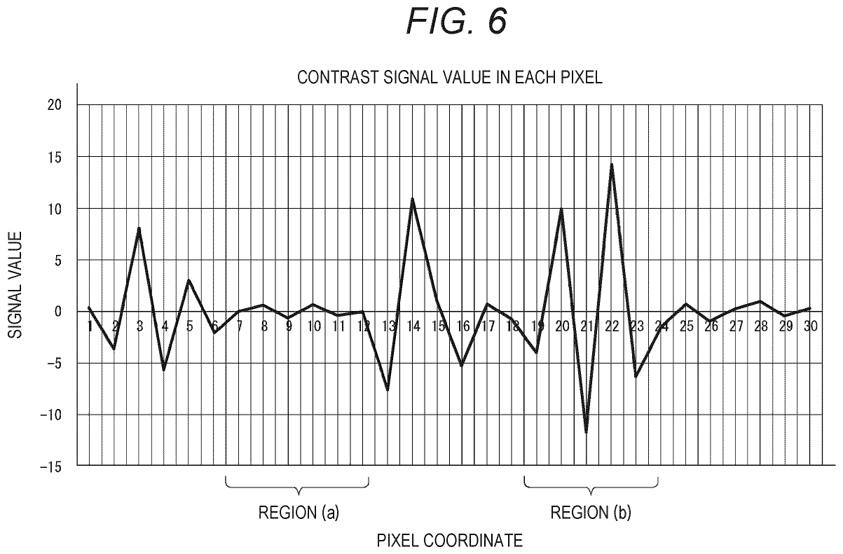

FIG. 6 illustrates, as the contrast signal value in each pixel, the contrast signal value of each pixel in the same row as in the case of FIG. 5. The contrast signal value mentioned here means a signal value of a contrast image obtained by the contrast extraction unit 42 on the basis of the original image described above.

As illustrated in the graph, in the contrast image, both of the component of the flat portion (the component of the region (a)) including the texture and the noise and the component of the edge (the component of the region (b)) are extracted.

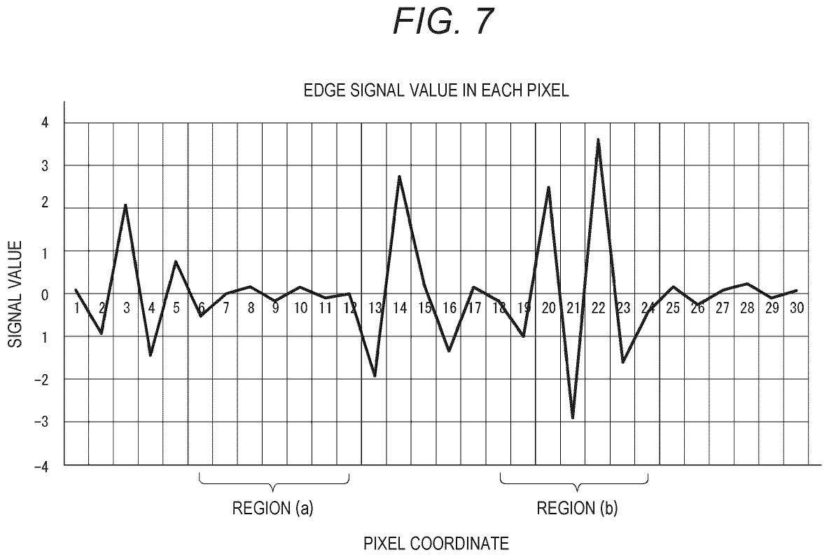

FIG. 7 illustrates, as the edge signal value in each pixel, the edge signal value of each pixel in the same row as in the case of FIG. 5. The edge signal value mentioned here means a signal value of an edge image obtained by the edge extraction unit 43 on the basis of the original image described above.

As illustrated, in the edge image, the edge component (the component of the region (b)) is mainly extracted.

In FIG. 3, the edge-enhancement processing unit 45 performs processing of multiplying the contrast image obtained by the contrast extraction unit 42 by a coefficient determined according to a signal value of the edge image to obtain an edge-enhanced contrast image.

Specifically, the edge-enhancement processing unit 45 obtains a gain value corresponding to the signal value of the pixel for each pixel of the edge image. Then, the signal value of each pixel of the contrast image is amplified by the gain value obtained for each pixel as described above to obtain an edge-enhanced contrast image.

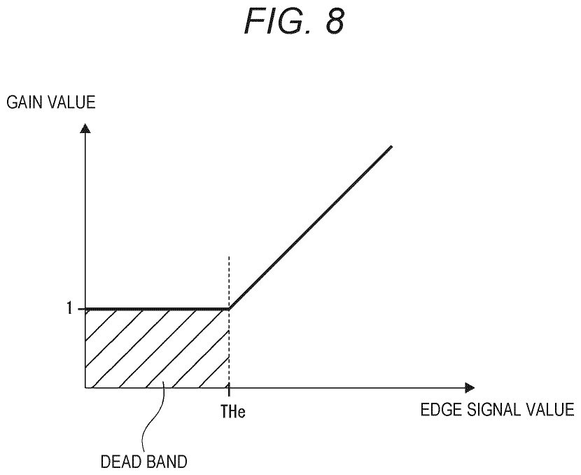

FIG. 8 is a graph for describing a setting example of a gain value based on an edge signal value.

The edge-enhancement processing unit 45 determines whether or not the edge signal value is equal to or larger than a predetermined threshold value THe for each pixel of the edge image, and sets the gain value of the pixel to “1” when the edge signal value is not equal to or larger than the threshold value THe, and sets the gain value of the pixel to a value larger than “1” when the edge signal value is equal to or larger than the threshold value THe. Specifically, in the present example, in the region where the edge signal value is equal to or larger than the threshold value THe, the gain value is set such that the gain value increases with a positive correlation with the edge signal value as illustrated in the graph.

Here, setting the gain value to “1” in the region where the edge signal value is less than the threshold value THe as described above means that the signal value is not amplified for the pixel in which the edge signal value is less than the threshold value THe, that is, the pixel regarded as the noise component with respect to the signal value amplification of the contrast image.

Therefore, the signal value amplification of the contrast image is not performed for a portion regarded as a noise component in the edge image.

Therefore, it is possible to prevent a noise component from being superimposed on the contrast image.

On the other hand, setting the gain value larger than “1” in the region where the edge signal value is equal to or larger than the threshold value THe means that the signal value is amplified for the pixel regarded as the edge component in the signal value amplification of the contrast image.

Therefore, according to the amplification processing of the edge-enhancement processing unit 45 described above, it is possible to selectively amplify only the edge component of the contrast image without amplifying the noise component.

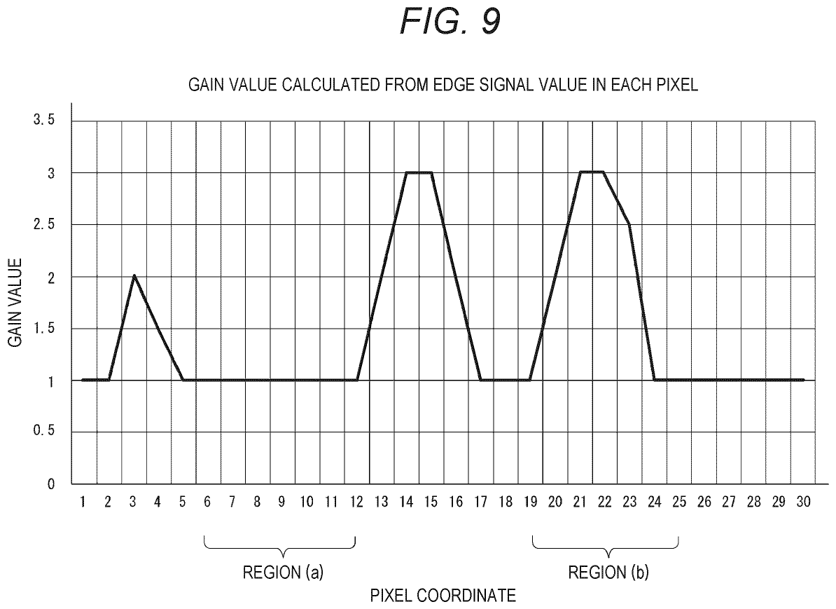

FIG. 9 illustrates an example of the gain value calculated by the edge-enhancement processing unit 45 on the basis of the edge signal value for the same row as in the case of FIG. 5 as the gain value calculated from the edge signal value in each pixel.

As described above, since the gain value is calculated to be a value of “1” or more only for the pixel in which the edge signal value is equal to or larger than the threshold value THe, gain values of “1” or more are calculated only for the region (b) including the edge component, and the gain value =“1” is calculated for the region (a) including the noise.

In FIG. 3, the amplification unit 44 amplifies the luminance value of the low-luminance image region input from the target region control unit 41 to obtain an amplified image.

The addition unit 46 adds the edge-enhanced contrast image obtained by the edge-enhancement processing unit 45 and the amplified image obtained by the amplification unit 44. In other words, the edge-enhanced contrast image is superimposed on the amplified image. Hereinafter, an image obtained by superimposing the amplified image on the edge-enhanced contrast image in this manner will be referred to as a superimposed image.

In the present embodiment, the superimposed image is a corrected image for the SDR image.

The addition unit 47 adds the SDR image input through the gamma correction unit 35 and the superimposed image input from addition unit 46. In other words, the superimposed image is superimposed on the SDR image. This corresponds to superimposing the edge-enhanced contrast image by the edge-enhancement processing unit 45 and the amplified image (the gain-up image of the low-luminance image region) by the amplification unit 44 on the SDR image.

As described above, the SDR processing unit 15 outputs the SDR image (the SDR image on which the superimposed image is superimposed) corrected by the correction processing unit 40 as described above to the display device 10 via the formatter 36 as the moving image data in the SDR video format.

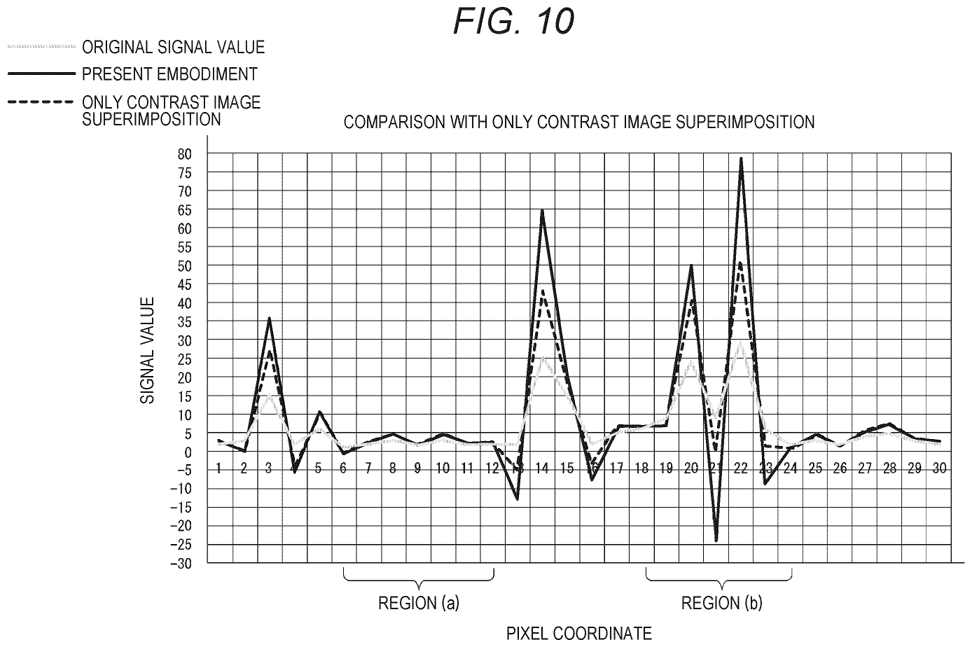

The correction effect of the SDR image by the correction processing unit 40 will be described with reference to FIGS. 10 to 12.

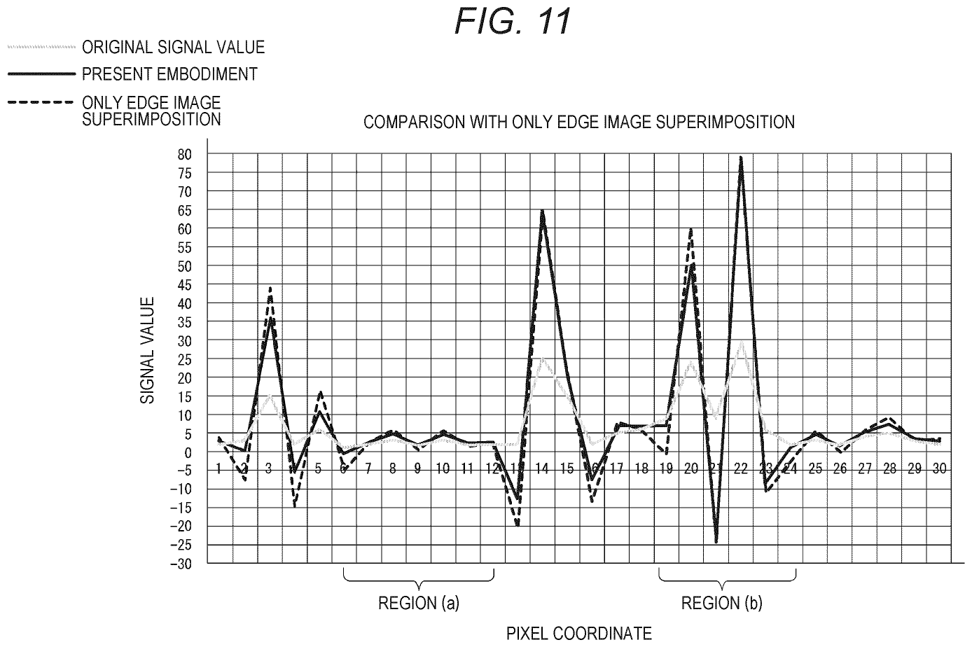

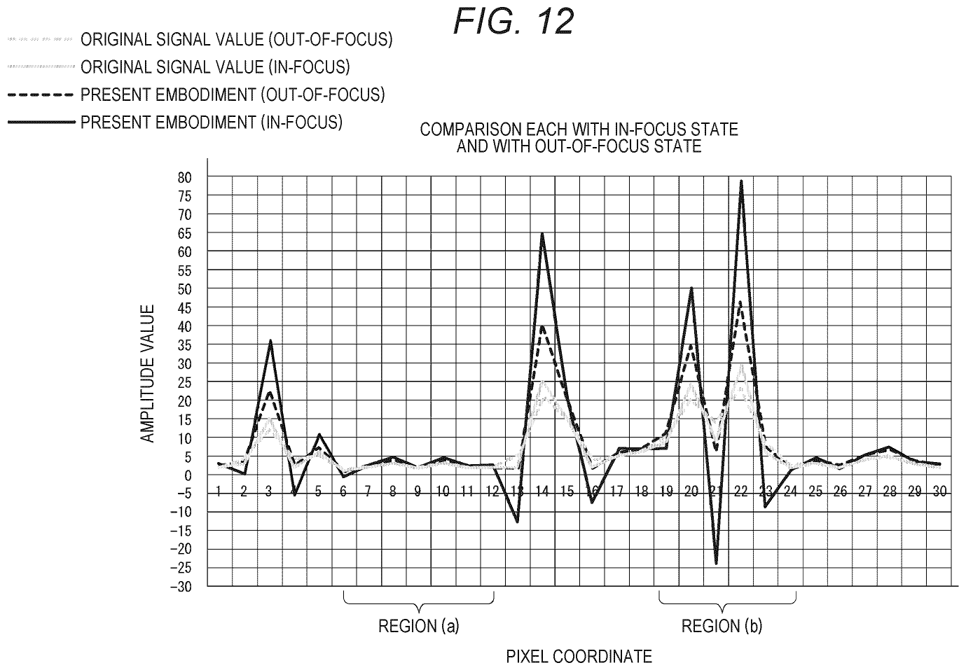

FIG. 10 illustrates a comparison result with the technique of Patent Document 2 described above as a comparison with only the contrast image superimposition. Note that, also in FIGS. 11 and 12 described below starting from FIG. 10, the target row in the captured image is the same row as in the case of FIG. 5, and includes the region (a) and the region (b).

In FIG. 10, a gray solid line indicates the original signal value of each pixel, a black dot line indicates the signal value of each pixel of the image after correction (SDR image after correction) in a case where the technology of Patent Document 2 is applied, and a black solid line indicates the signal value of each pixel of the image after correction (image after correction obtained by using the above-described superimposed image as a corrected image) of the present embodiment.

In the case of only the contrast image superimposition of Patent Document 2, the contrast component including the edge component is enhanced with respect to the original image, but the edge portion is enhanced more in the case of the present embodiment (particularly, refer to the portion of the region (b)).

FIG. 11 illustrates a comparison result with the technique of Patent Document 3 described above as a comparison with only the edge image superimposition. Specifically, in FIG. 11, a gray solid line indicates the original signal value of each pixel, a black dot line indicates the signal value of each pixel of the image after correction in a case where the technology of Patent Document 3 is applied, and a black solid line indicates the signal value of each pixel of the image after correction of the present embodiment.

As shown in the graph, according to the present embodiment, it can be seen that the edge portion is enhanced in a similar manner as the case of applying the edge enhancement (contour emphasis) technique of Patent Document 3.

Here, referring to FIG. 10, in the present embodiment, it can be seen that the degree of enhancement of the flat portion (portion including noise) of the region (a) is substantially equal to that of the case of only the contrast image superimposition. This indicates that, in the present embodiment, only the edge portion of the contrast component is enhanced, and the noise component is not enhanced.

By superimposing the contrast image, the contrast component for the low-luminance image region is enhanced, and the visibility is improved. At this time, in the present embodiment, the target captured image is an RGB color image. Therefore, by superimposing the contrast image, the degree of restoration of the color tone is improved for the low-luminance image region.

Furthermore, in the present embodiment, since the amplified image by the amplification unit 44 is also superimposed, the visibility of the low-luminance image region can be improved also in terms of brightness.

FIG. 12 illustrates a comparison result with the original signal value and with the signal value of the image after correction of the present embodiment as each comparison with the in-focus state and with the out-of-focus state. Specifically, in FIG. 12, a gray dotted line indicates the original signal value of each pixel of out-of-focus state, a gray solid line indicates the original signal value of each pixel of in-focus state, a black dot line indicates the signal value of the image after correction of each pixel of out-of-focus state, and a gray solid line indicates the signal value of the image after correction of each pixel of in-focus state.

Taking notice of in-focus state, it can be confirmed that the signal value of the present embodiment is larger than the original signal value in the edge portion. In addition, also for the out-of-focus state, it can be confirmed that the signal value of the present embodiment is larger than the original signal value.

Furthermore, it can be confirmed that the signal value of the present embodiment is larger than the original signal value also as the signal value difference between the in-focus state and the out-of-focus state.

From this result, according to the present embodiment, it can be seen that the easiness of the in-focus confirmation in the low-luminance image region is improved. In other words, even in a case where a dark portion is captured, it can be seen that the easiness of the in-focus confirmation in the through-the-lens image is improved.

Here, an example in which the correction processing as the present embodiment is realized by hardware processing has been described above, but the correction processing as the present embodiment can also be realized by software processing by a computer device.

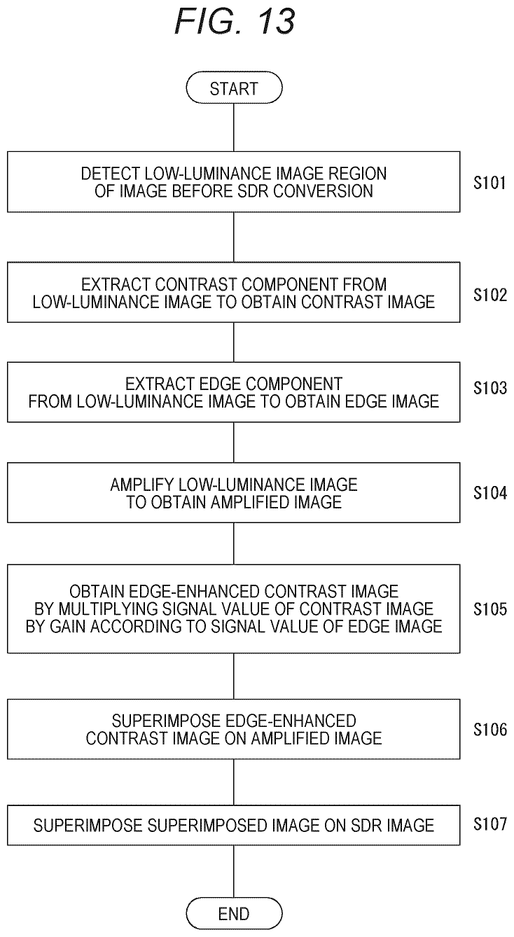

FIG. 13 is a flowchart illustrating a specific processing procedure example to be executed in a case where the correction processing as the present embodiment is realized by software processing. Here, it is assumed that the execution subject of the processing is a CPU.

First, in step S101, the CPU performs processing of detecting a low-luminance image region of an image before SDR conversion.

In step S102 following step S101, the CPU extracts a contrast component from the low-luminance image to obtain a contrast image. The low-luminance image mentioned here means an image of the low-luminance image region detected in step S101. In step S102, processing of extracting frequency components equal to or larger than the first cutoff frequency fc1 is performed on the low-luminance image to obtain a contrast image.

In step S103 following step S102, the CPU extracts an edge component from the low-luminance image to obtain an edge image. That is, processing of extracting frequency components equal to or larger than the second cutoff frequency fc2 is performed on the low-luminance image to obtain an edge image.

In step S104 following step S103, the CPU amplifies the low-luminance image to obtain an amplified image.

In step S105 following step S104, the CPU obtains an edge-enhanced contrast image by multiplying the signal value of the contrast image by a gain according to the signal value of the edge image. That is, as described above as the processing of the edge-enhancement processing unit 45, it is determine whether or not the edge signal value is equal to or larger than a predetermined threshold value THe for each pixel of the edge image, and sets the gain value of the pixel to “1” when the edge signal value is not equal to or larger than the threshold value THe, and sets the gain value of the pixel to a value larger than “1” when the edge signal value is equal to or larger than the threshold value THe. At this time, in the region where the edge signal value is equal to or larger than the threshold value THe, the gain value is set such that the gain value increases with a positive correlation with the edge signal value as exemplified in FIG. 8. Then, the signal value of each pixel of the contrast image is amplified by the gain value obtained for each pixel as described above to obtain an edge-enhanced contrast image.

In step S106 following step S105, the CPU performs processing of superimposing the edge-enhanced contrast image on the amplified image. That is, the above-described superimposed image is obtained.

Then, in step S107 following step S106, the CPU performs processing of superimposing the superimposed image on the SDR image, and terminates the series of processing shown in FIG. 13.

Note that the order of executing the processing of step S102 (contrast extraction processing), the processing of step S103 (edge extraction processing), the processing of step S104 (amplification processing), and the processing of step S105 (edge enhancement processing) is not limited to the above-described order. For example, the order of steps S102 and S103 may be switched. Furthermore, after step S104 is executed, the processing of steps S102 and S103 may be executed. Alternatively, it is also conceivable to execute the processing of step S104 after executing the processing of steps S102, S103, and S104.

### 2. Second Embodiment

Next, the second embodiment will be described.

The second embodiment relates to switching of a correction mode.

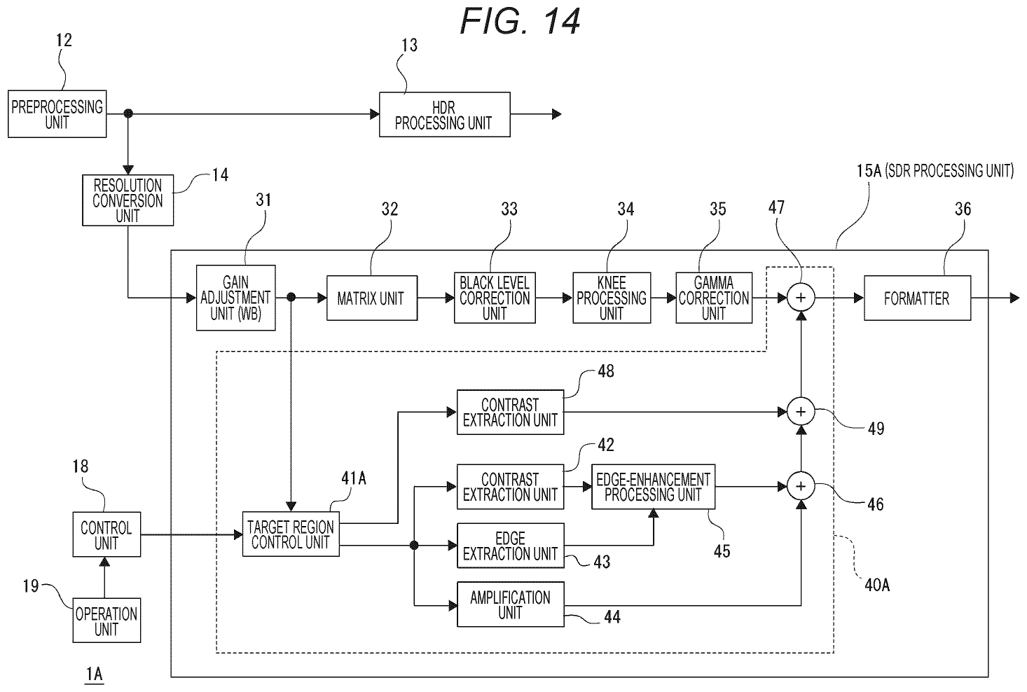

FIG. 14 is a diagram for describing a configuration example of an imaging device 1A as a second embodiment.

Note that, although not illustrated, the imaging unit 11, the communication unit 16, and the communication unit 17 included in the imaging device 1 are similarly included in the imaging device 1A.

In the following description, the same reference numerals are given to portions similar to those already described, and description thereof will be omitted.

The imaging device 1A is different from the imaging device 1 in that an SDR processing unit 15A is provided instead of the SDR processing unit 15.

The SDR processing unit 15A is different from SDR processing unit 15 in that a target region control unit 41A is provided instead of the target region control unit 41, and a contrast extraction unit 48 and an addition unit 49 are added.

Here, the contrast extraction unit 48 and the addition unit 49 are added to realize correction for improving the reproducibility of the high-luminance image region as in Patent Document 1 described above.

The target region control unit 41A has a function of detecting a low-luminance image region and a function of detecting a high-luminance image region. The high-luminance image region mentioned here means a region where the luminance value is the second threshold value or more.

In the second embodiment, as the correction mode of the SDR image, it is possible to perform correction in three modes of a low-luminance correction mode in which the correction using the superimposed image described in the first embodiment is performed for the low-luminance image region of the SDR image, a high-luminance correction mode in which the correction using the contrast image extracted from the high-luminance image region as in Patent Document 1 is performed for the high-luminance image region of the SDR image, and a compatible mode in which both the correction in the low-luminance correction mode and the correction in the high-luminance correction mode are performed.

In the present example, the correction mode is switched on the basis of a user operation via the operation unit 19. That is, in this case, the control unit 18 is instructed which correction mode among the above-described three modes is to be selected by the operation of the operation unit 19. The control unit 18 notifies the target region control unit 41A of the instructed correction mode.

The target region control unit 41A performs processing as follows for each of the notified correction modes.

That is, in a case where the low-luminance correction mode is notified, the target region control unit 41A outputs the luminance value of each pixel of the low-luminance image region detected from the input image to the contrast extraction unit 42, the edge extraction unit 43, and the amplification unit 44. In this case, for the high-luminance image region, for example, “0” is output to the contrast extraction unit 48 as the luminance value.

Furthermore, in a case where the high-luminance correction mode is notified, the target region control unit 41A outputs the luminance value of each pixel of the high-luminance image region detected from the input image to the contrast extraction unit 48. In this case, for the high-luminance image region, for example, “0” is output as the luminance value to the contrast extraction unit 42, the edge extraction unit 43, and the amplification unit 44.

In a case where the compatible mode is notified, the target region control unit 41A outputs the luminance value of each pixel of the low-luminance image region detected from the input image to the contrast extraction unit 42, the edge extraction unit 43, and the amplification unit 44, and outputs the luminance value of each pixel of the high-luminance image region to the contrast extraction unit 48.

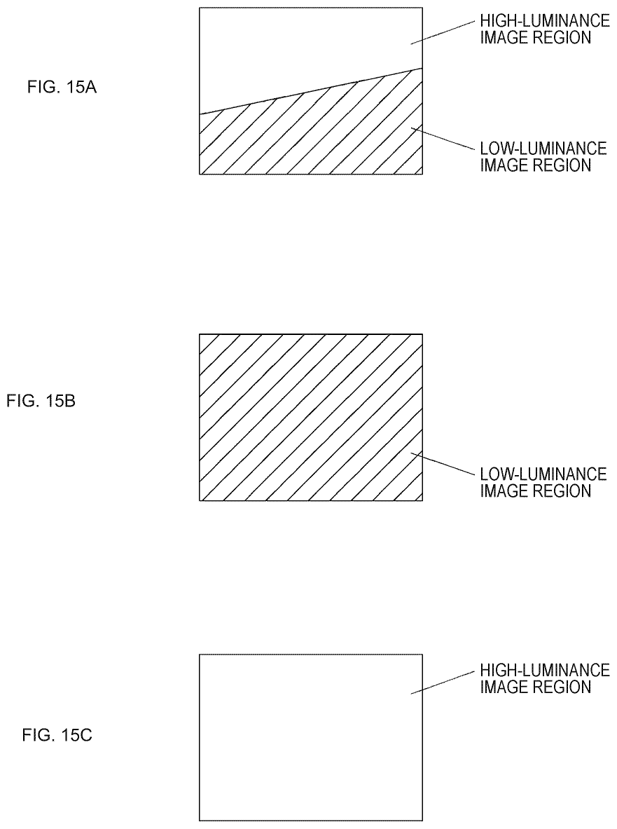

Here, as the input image to the target region control unit 41A, there may be a case where the low-luminance image region and the high-luminance image region are mixed as illustrated in FIG. 15A, a case where only the low-luminance image region exists as illustrated in FIG. 15B, and a case where only the high-luminance image region exists as illustrated in FIG. 15C.

In the compatible mode, in a case where only the low-luminance image region exists in the input image as illustrated in FIG. 15B, the luminance value of the high-luminance image region is not input to the contrast extraction unit 48. That is, the contrast extraction unit 48 does not generate a contrast image for improving the reproducibility of the high-luminance image region.

In a similar manner, in a case where only the high-luminance image region exists in the input image as illustrated in FIG. 15C, the luminance value of the low-luminance image region is not input to the contrast extraction unit 42, the edge extraction unit 43, and the amplification unit 44. That is, in this case, the corrected image (the superimposed image of the edge-enhanced contrast image and the amplified image) as the embodiment is not generated.

In FIG. 14, the addition unit 49 adds the superimposed image obtained by the addition unit 46 and the contrast image (high-luminance contrast image) for the high-luminance image region obtained by the contrast extraction unit 48, and outputs the result to the addition unit 47.

With the above-described configuration, in the imaging device 1A, the correction in the low-luminance correction mode, the correction in the high-luminance correction mode, and the correction in the compatible mode can be selectively performed as the correction on the SDR image.

Note that, in the above-described configuration, a first threshold value and a second threshold value set in the target region control unit 41A to detect the low-luminance image region and the high-luminance image region can be changed on the basis of an operation. Therefore, the user can adjust the luminance region to which the contrast is desired to be added.

Furthermore, the first threshold value and the second threshold value described above are not limited to different values (first threshold value < second threshold value), and may be the same value.

Furthermore, in the above description, the configuration has been exemplified in which the switching among the low-luminance correction mode, the high-luminance correction mode, and the compatible mode is realized by controlling the luminance value input to the contrast extraction unit 42, the edge extraction unit 43, the amplification unit 44, and the contrast extraction unit 48. However, switching among the low-luminance correction mode, the high-luminance correction mode, and the compatible mode can be realized by switching which image is output as the corrected image of the SDR image in the subsequent stage of the contrast extraction unit 48 and the addition unit 46. Specifically, only the superimposed image obtained by the addition unit 46 is output as the corrected image in the low-luminance correction mode, only the high-luminance contrast image obtained by the contrast extraction unit 48 is output as the corrected image in the high-luminance correction mode, and an image in which the superimposed image and the high-luminance contrast image are superimposed is output as the corrected image in the compatible mode.

Here, the switching control of the correction mode may be performed such that the switching is performed between a first state (a state of the compatible mode) in which the superimposed image and the high-luminance contrast image are superimposed on the SDR image, a second state (a state of the low-luminance correction mode) in which only the superimposed image is superimposed on the SDR image in the superimposed image and the high-luminance contrast image, and a third state (a state of the high-luminance correction mode) in which only the high-luminance contrast image is superimposed on the SDR image in the superimposed image and the high- high-luminance contrast image.

### 3. Third Embodiment

A third embodiment relates to adjustment of a cutoff frequency.

Specifically, the frequency band of the contrast image by the contrast extraction unit 42 and the frequency band of the edge image by the edge extraction unit 43 can be changed according to the operation.

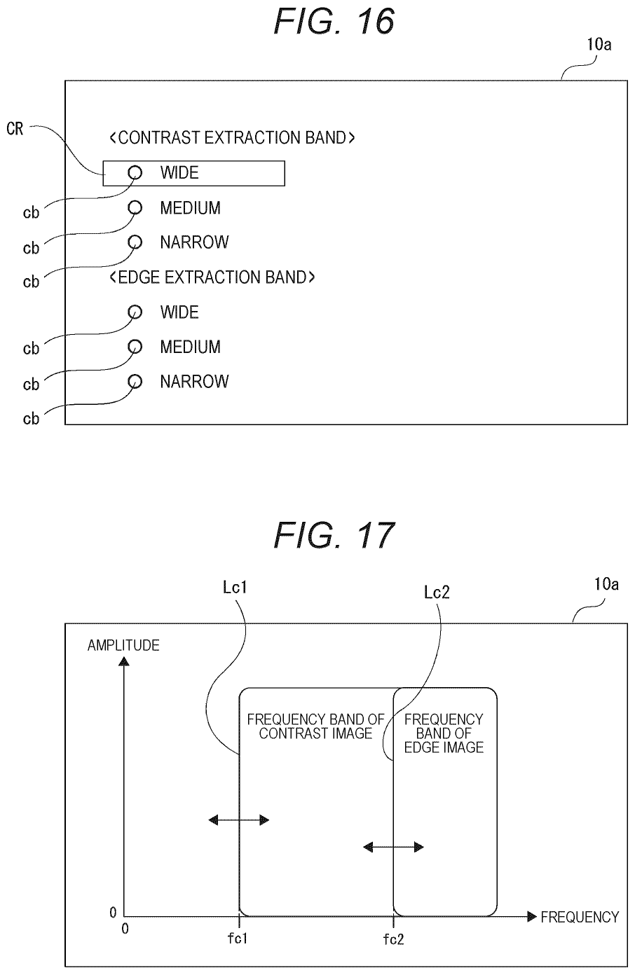

Specific examples of the operation of changing the frequency band include, for example, an operation of selecting from a plurality of setting items as illustrated in FIG. 16, an operation of deforming a figure indicating the frequency band as illustrated in FIG. 17, and the like.

Specifically, in the example of FIG. 16, regarding the extraction band (the contrast extraction band in the diagram) of the contrast component in the contrast extraction unit 42 and the extraction band (the edge extraction band in the diagram) of the edge component by the edge extraction unit 43 in the form of a setting menu displayed on a display screen 10a of the display device 10, candidates of changeable frequency bands such as “wide”, “medium”, “narrow”, and the like are presented. A check box cb is provided in each candidate, and the user performs a predetermined determination operation in a state where the illustrated cursor CR is positioned as a desired candidate, so that the check box cb for the desired candidate among the presented candidates can be checked for each of the contrast extraction band and the edge extraction band, and a desired frequency band can be selected. That is, a desired frequency can be selected from among candidate frequencies for each of the first cutoff frequency fc1 and the second cutoff frequency fc2.

Furthermore, in the example of FIG. 17, figure information indicating a frequency band is displayed on the display screen 10a for each of the contrast image and the edge image. Specifically, in the present example, substantially quadrangular figure information is displayed as graphic information indicating these frequency bands.

The user can perform an operation of moving vertical line portions Lc1 and Lc2 (left side vertical line portions in a substantially rectangular figure in the diagram) indicating the lower limit frequency of the frequency band in the figure information indicating such a frequency band to the left and right. With this operation, it is possible to select a frequency band for each of the contrast image and the edge image. In other words, each of the first cutoff frequency fc1 and the second cutoff frequency fc2 can be selected.

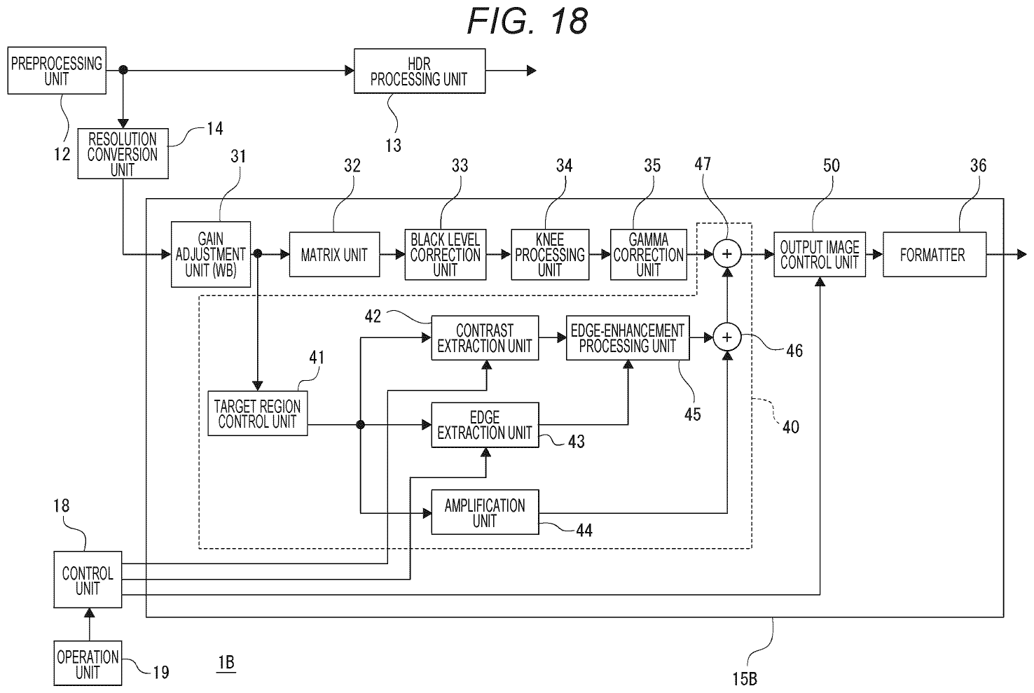

FIG. 18 is a diagram for describing a configuration example of an imaging device 1B as a third embodiment that enables change of an extraction band based on the operation such as described above. Note that, although not illustrated, the imaging unit 11, the communication unit 16, and the communication unit 17 included in the imaging device 1 are similarly included also in the imaging device 1B.

The imaging device 1B is different from the imaging device 1 in that an SDR processing unit 15B is provided instead of the SDR processing unit 15. The SDR processing unit 15B is different from the SDR processing unit 15 in that an output image control unit 50 is added between the addition unit 47 and the formatter 36.

Furthermore, in the SDR processing unit 15B, the contrast extraction unit 42 is configured to be able to change the first cutoff frequency fc1 on the basis of an instruction from the control unit 18, and the edge extraction unit 43 is configured to be able to change the second cutoff frequency fc2 on the basis of an instruction from the control unit 18.

The control unit 18 instructs the output image control unit 50 to generate a graphical user interface (GUI) image (SDR image) for receiving the selection operation of the first cutoff frequency fc1 and the second cutoff frequency fc2 as illustrated in FIGS. 16 and 17, and outputs the GUI image to the formatter 36. That is, the GUI image is displayed on the display device 10.

Furthermore, in a state where the GUI image described above is displayed on the display device 10, in response to the user operation on the operation unit 19, specifically, the selection operation of the first cutoff frequency fc1 and the second cutoff frequency fc2 as illustrated in FIGS. 16 and 17, the control unit 18 instructs the contrast extraction unit 42 and the edge extraction unit 43 on the first cutoff frequency fc1 and the second cutoff frequency fc2 specified by the selection operation.

Therefore, each of the extraction band of the contrast component in the contrast extraction unit 42 and the extraction band of the edge component in the edge extraction unit 43 can be changed on the basis of the user operation. In other words, the effect of image quality improvement and the effect of easiness improvement of in-focus confirmation for the low-luminance image region can be changed on the basis of the user's operation.

Note that in the above description, although both the first cutoff frequency fc1 and the second cutoff frequency fc2 can be changed according to the operation in the above-described example, only one of these cutoff frequencies can be changed according to the operation.

### 4. Modification

Here, the embodiments are not limited to the specific example described above, and configurations as various modifications can be employed.

For example, variations in the configuration can be considered as to which part of which device performs the generation processing of the corrected image as the embodiment, which image is the image to be corrected, and the like. Hereinafter, six examples of the first to sixth modifications will be described with respect to modifications related to variations of the configuration.

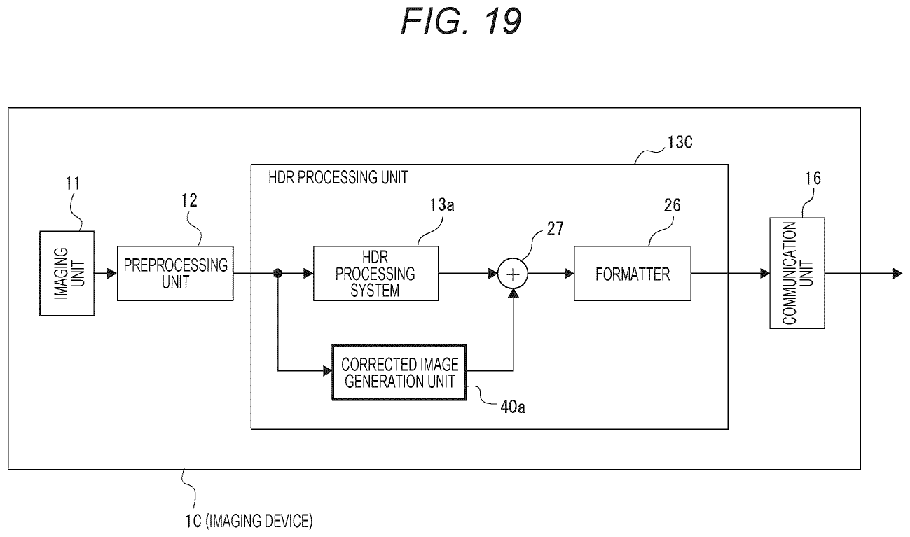

FIG. 19 is an explanatory diagram of a first modification.

In the first modification, generation processing of a corrected image is performed by an HDR processing unit in an imaging device, and an image to be corrected is an HDR image.

As illustrated, an imaging device 1C as the first modification includes an HDR processing unit 13C together with the imaging unit 11, the preprocessing unit 12, and the communication unit 16. The HDR processing unit 13C includes an HDR processing system 13a, a corrected image generation unit 40a, an addition unit 27, and the formatter 26. Here, the HDR processing system 13a represents a processing system from the gain adjustment unit 21 to gamma correction unit 25 included in the HDR processing unit 13 illustrated in FIG. 3. Furthermore, it represents a processing system from the target region control unit 41 to the addition unit 46 included in the correction processing unit 40 (that is, a processing system up to generation of a superimposed image).

As illustrated in the diagram, in the HDR processing unit 13C, the captured image processed by the preprocessing unit 12 is branched and input to the HDR processing system 13a and the corrected image generation unit 40a. Then, in the addition unit 27, the superimposed image generated by the corrected image generation unit 40a is superimposed on the HDR image obtained by the HDR processing system 13a. The HDR image on which the superimposed image is superimposed in this manner is output to the recording device 2 as moving image data in the HDR video format via the formatter 26 and the communication unit 16.

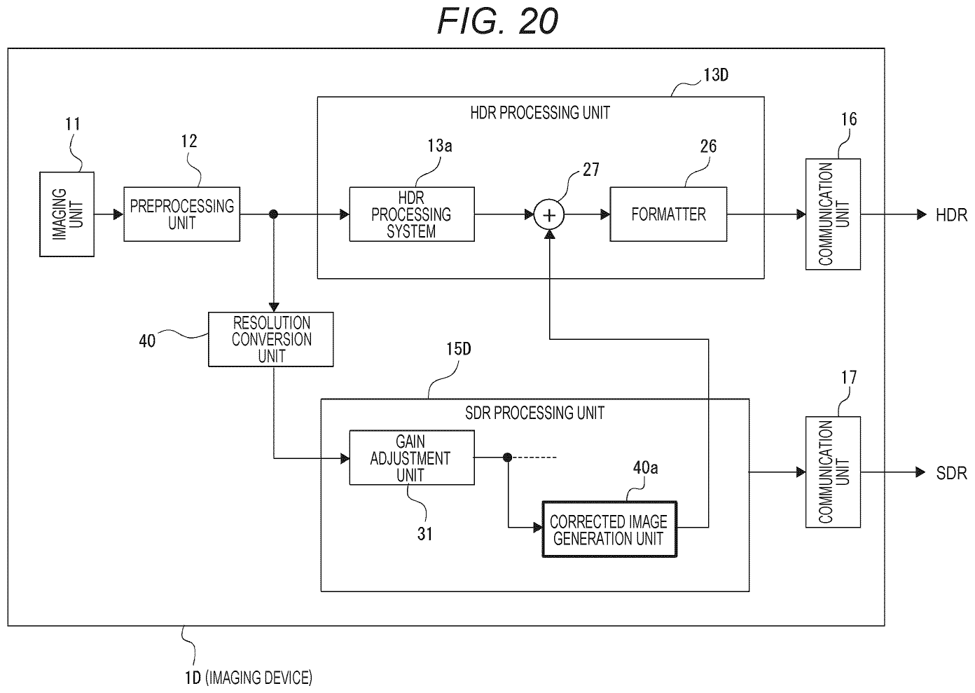

FIG. 20 is an explanatory diagram of a second modification.

In the second modification, generation processing of a corrected image is performed by a SDR processing unit in an imaging device, but an image to be corrected is an HDR image.

As illustrated, an imaging device 1D as the second modification is different from the imaging device 1 in that the HDR processing unit 13 is replaced with a HDR processing unit 13D, and the SDR processing unit 15 is replaced with the SDR processing unit 15D.

The SDR processing unit 15D includes the corrected image generation unit 40a in a similar manner as the SDR processing unit 15.

The HDR processing unit 13D includes the addition unit 27 between the HDR processing system 13a and the formatter 26 in a similar manner as the HDR processing unit 13C in FIG. 19.

As illustrated, in the imaging device 1D, the superimposed image generated by the corrected image generation unit 40a in the SDR processing unit 15D is superimposed on the HDR image by the addition unit 27 in the HDR processing unit 13D.

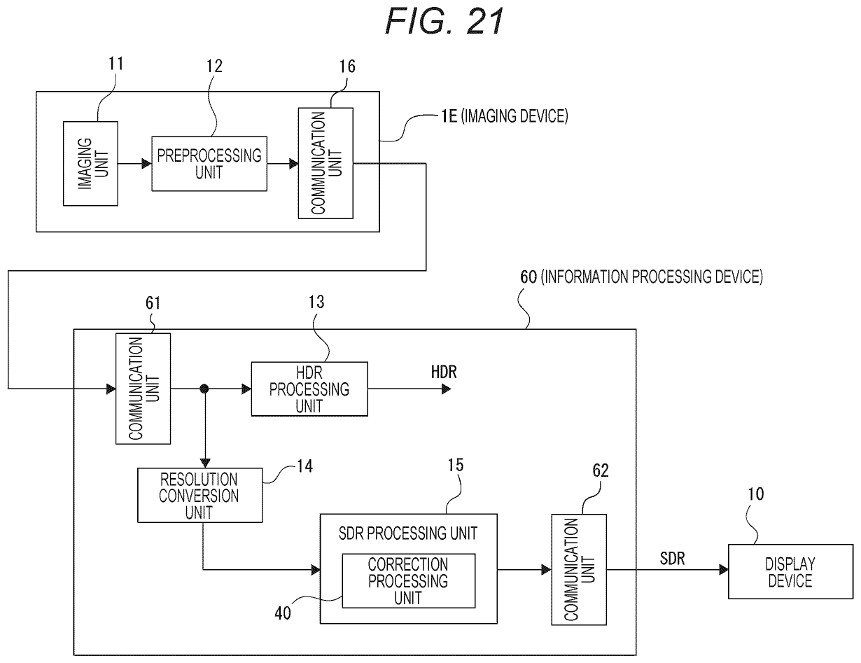

FIG. 21 is an explanatory diagram of a third modification.

In the third modification, a corrected image is generated by an SDR processing unit in an information processing device (for example, a CCU, a BPU, an adapter, and the like) outside an imaging device, and an image to be corrected is an SDR image.

As illustrated, an imaging device 1E according to the third modification includes the imaging unit 11, the preprocessing unit 12, and the communication unit 16, but does not include the HDR processing unit 13 or the SDR processing unit 15.

The information processing device 60 includes a communication unit 61, the HDR processing unit 13, the resolution conversion unit 14, the SDR processing unit 15, and a communication unit 62.

In the information processing device 60, the communication unit 61 is provided to perform data communication with the imaging device 1E. Furthermore, the communication unit 62 is provided to output an SDR image as a through-the-lens image to the display device 10.

As illustrated, in the information processing device 60, the captured image obtained by the imaging unit 11 of the imaging device 1E is received by the communication unit 61 via the preprocessing unit 12 and the communication unit 16, and the captured image received by the communication unit 61 is branched and input to the HDR processing unit 13 and the resolution conversion unit 14.

In this case, the SDR image after correction obtained by the SDR processing unit 15 is output to the display device 10 via the communication unit 62 and displayed as a through-the-lens image.

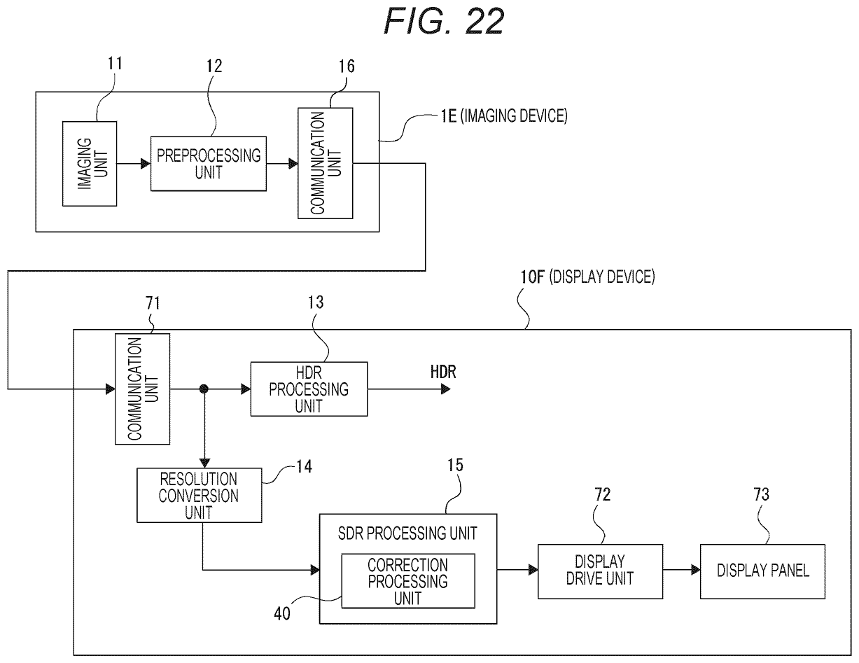

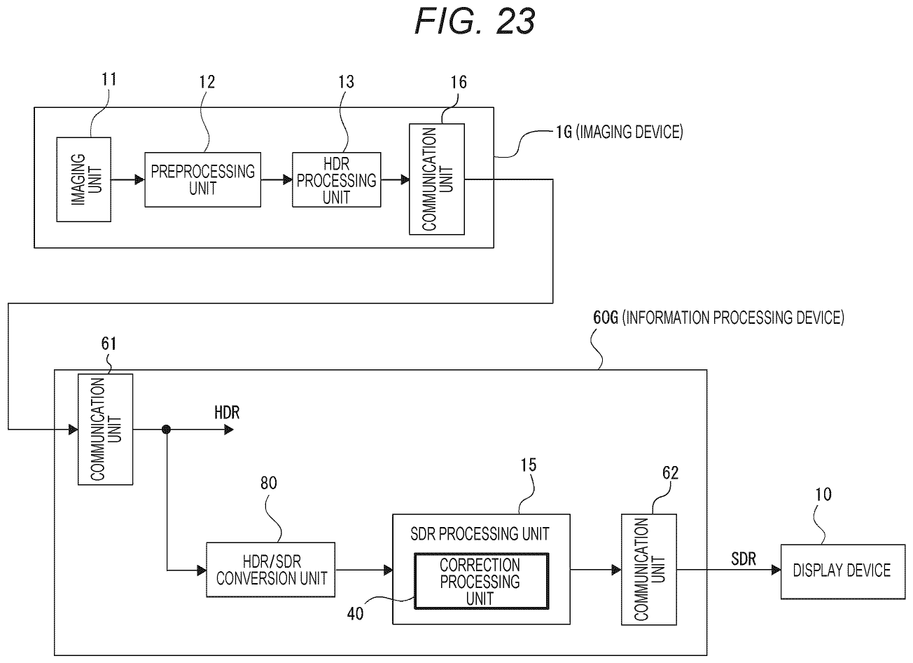

FIG. 22 is an explanatory diagram of a fourth modification.

In the fourth modification, a corrected image is generated by an SDR processing unit provided in a display device that displays a through-the-lens image, and an image to be corrected is an SDR image.

As illustrated, a display device 10F of the fourth modification includes a communication unit 71, the HDR processing unit 13, the resolution conversion unit 14, the SDR processing unit 15, a display drive unit 72, and a display panel 73. The communication unit 71 receives the captured image output from the communication unit 16 of the imaging device 1E.

In the display device 10F, the captured image received by the communication unit 71 is branched and input to the HDR processing unit 13 and the resolution conversion unit 14. In this case, the SDR image after correction obtained by the SDR processing unit 15 is output to the display drive unit 72. The display drive unit 72 drives the display panel 73 configured by, for example, a liquid crystal panel or an organic EL panel, and the like to display an image on the basis of the input SDR image. Therefore, the SDR image after the correction is displayed as a through-the-lens image on the display panel 73.

FIG. 23 is an explanatory diagram of a fifth modification.

In the fifth modification, in a similar matter as in the third modification (FIG. 21), the SDR processing unit in the information processing device (for example, a CCU, a BPU, an adapter, and the like) outside the imaging device generates the corrected image, and an image to be corrected is the SDR image. However, the fifth modification is different in that the moving image data in the HDR video format is generated in the imaging device, and the information processing device performs the HDR/SDR conversion.

In the fifth modification, the imaging device 1G is different from the imaging device 1E in that the HDR processing unit 13 is provided between the preprocessing unit 12 and the communication unit 16.

An information processing device 60G is different from the information processing device 60 in that the HDR processing unit 13 is omitted and an HDR/SDR conversion unit 80 is provided instead of the resolution conversion unit 14.

The HDR/SDR conversion unit 80 converts moving image data in the HDR video format input from the imaging device 1G via the communication unit 61 into an SDR image. The SDR processing unit 15 in this case generates a superimposed image using the SDR image obtained by the HDR/SDR conversion unit 80 as an input image and corrects the SDR image using the superimposed image. Also in this case, the SDR image after correction output from the SDR processing unit 15 is output to the display device 10 via the communication unit 62 and displayed.

Note that, in the SDR processing unit 15 in this case, the knee processing unit 34 is unnecessary.

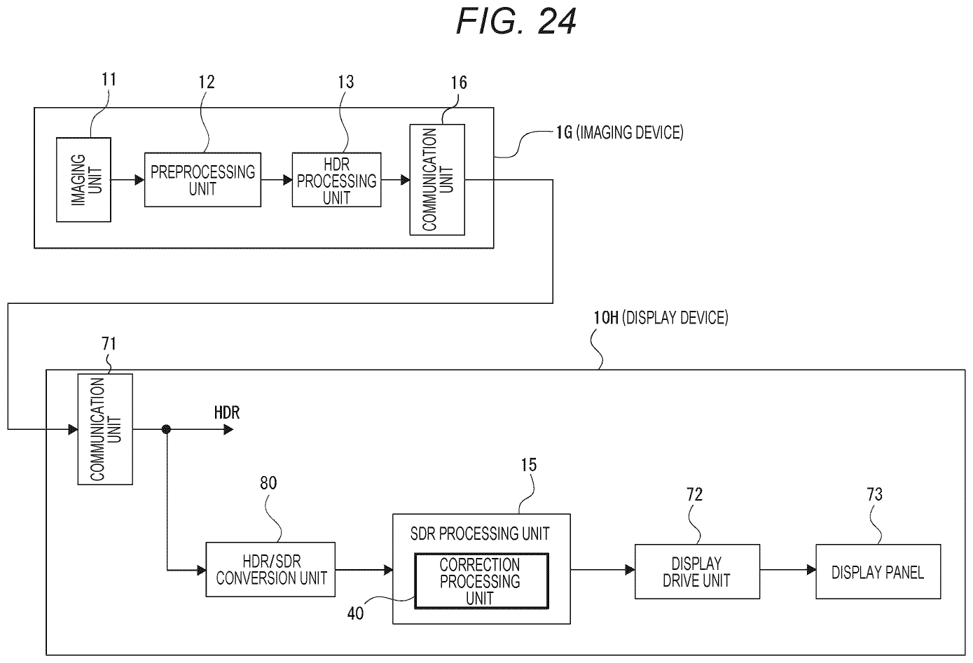

FIG. 24 is an explanatory diagram of a sixth modification.

In a sixth modification, the SDR image correction in the fifth modification is applied to a display device.

As illustrated, in the sixth modification, a display device 10H is different from the display device 10F (FIG. 22) in that the HDR/SDR conversion unit 80 is provided instead of the resolution conversion unit 14.

In the SDR processing unit 15 in this case, the generation of the superimposed image and the correction of the SDR image using the superimposed image are performed using the SDR image obtained by the HDR/SDR conversion unit 80 as the input image, and the display drive unit 72 drives the display panel 73 to display an image on the basis of the SDR image after the correction, so that the SDR image after the correction is displayed as the through-the-lens image on the display device 10H.

Note that, also in the SDR processing unit 15 in this case, the knee processing unit 34 is unnecessary.

Here, in the above description, the case where the captured image serving as the generation source of the superimposed image as the corrected image is the RGB color image has been exemplified, but the present technology can also be suitably applied to a case where the captured image is the monochrome image.

Furthermore, in the above description, an example has been described in which the present technology is applied to an imaging system that obtains a captured image for broadcasting, but the present technology can also be suitably applied to an imaging system that obtains a captured image for use other than broadcasting.

Moreover, in the above description, an example has been described in which the conversion from a HDR image to an SDR image, that is, the processing of converting a captured image according to a first dynamic range into a luminance suppressed image is performed by the knee processing, but the conversion can also be performed using, for example, the matrix unit 32 (color matrix) or the gamma correction unit 35. That is, the conversion processing into the luminance suppressed image is not limited to the knee processing.

Note that, in a case where a bit depth is converted in the conversion from HDR to SDR, the conversion processing of the bit depth can be performed by the gamma correction unit 35 or the formatter 36.

### 5. Summary of Embodiments

As described above, an image processing apparatus (imaging devices 1, 1A, 1B, 1C, and 1D, information processing devices 60 and 60G, and display devices 10F and 10H) includes: a contrast extraction unit (contrast extraction unit 42) that obtains a contrast image by extracting a contrast component from an input image based on a captured image; an edge extraction unit (edge extraction unit 43) that obtains an edge image by extracting an edge component from the input image; an edge-enhancement processing unit (edge-enhancement processing unit 45) that obtains an edge-enhanced contrast image by performing processing of multiplying the contrast image by a coefficient determined according to a signal value of the edge image; an image amplification unit (image amplification unit 44) that obtains an amplified image by amplifying the input image; and a superimposed image generation unit (addition unit 46) that obtains a superimposed image obtained by superimposing the edge-enhanced contrast image on the amplified image.

In the edge image, the signal value increases as approaching the in-focus state. Therefore, in the superimposed image in which the edge-enhanced contrast image obtained on the basis of the edge image is superimposed on the amplified image of the input image as described above, the edge portion is enhanced as approaching the in-focus state, and it is possible to improve the easiness of the in-focus confirmation by using the superimposed image as the corrected image for the output target image such as the through-the-lens image or the like. Then, since the edge-enhanced contrast image is generated by multiplying the contrast image by a coefficient determined according to the signal value of the edge image, it is possible to prevent the signal value amplification of the contrast image from being performed for a portion having a small signal value in the edge image, that is, a portion regarded as noise. Therefore, it is possible to prevent a noise component from being superimposed on the superimposed image. Furthermore, according to the above-described configuration, since the contrast component extracted from the input image can be superimposed on the output target image, it is possible to improve the reproducibility of the low-luminance image region in the case of capturing the dark portion.

Therefore, according to the present embodiments, it is possible to achieve the image quality improvement while achieving the easiness improvement of in-focus confirmation for the image obtained by capturing the dark portion.

Furthermore, the image processing apparatus as the embodiment includes a low luminance region detection unit (target region control unit 41) that detects a low-luminance image region, which is a region having a luminance value of a predetermined value or less, from an input image, and the contrast extraction unit and the edge extraction unit extract a contrast component and an edge component for the low-luminance image region in the input image.

Therefore, it is possible to prevent the correction based on the superimposed image from being performed on the image region other than the low-luminance image region in a case where the low-luminance image region does not exist or in a case where the image region other than the low-luminance image region is included in the input image.

Therefore, it is possible to prevent an image region for which correction based on the superimposed image is unnecessary from being performed. That is, it is possible to prevent image quality deterioration due to inadvertent edge enhancement in an image region other than the low-luminance image region.

Moreover, in the image processing apparatus as the embodiment, the edge-enhancement processing unit does not amplify the signal value of the pixel in which the signal value in the edge image is less than the predetermined threshold value in the signal value amplification of the contrast image.

Therefore, the signal value amplification of the contrast image is not performed for a portion regarded as a noise component in the edge image.

Therefore, it is possible to prevent the noise component from being superimposed on the superimposed image, and it is possible to achieve the image quality improvement for the displayed image.

Furthermore, in the image processing apparatus as the embodiment, the input image is an RGB image.

In a case where a dark portion is captured, by extracting a contrast component from an input RGB image and superimposing the contrast component on an output target image, it is possible to improve the reproducibility of color tone in a low-luminance image region of the output target image.

Furthermore, in the image processing apparatus as the embodiment, the contrast extraction unit extracts a contrast component by the first high-pass filter that extracts a frequency component of the input image by the first cutoff frequency (first cutoff frequency fc1), and the edge extraction unit extracts an edge component by the second high-pass filter that extracts a frequency component of the input image by the second cutoff frequency (second cutoff frequency fc2) higher in frequency than the first cutoff frequency.

Therefore, it is possible to appropriately extract a component including texture other than the edge portion of the subject as the contrast component.

Therefore, in the case of capturing the dark portion, it is possible to appropriately achieve the image quality improvement for the low-luminance image region.

Moreover, the image processing apparatus (imaging device 1B) as the embodiment includes a frequency control unit (control unit 18) that performs control to change at least one of the first and second cutoff frequencies in accordance with an operation.

Therefore, at least one of the effect of image quality improvement and the effect of easiness improvement of in-focus confirmation for the low-luminance image region can be changed on the basis of the user's operation.

Furthermore, in the image processing apparatus as the embodiment, for at least one of the first and second high-pass filters, figure information indicating a frequency band to be extracted is displayed on the display device, and the frequency control unit performs control to change the corresponding cutoff frequency between the first and second cutoff frequencies in accordance with an operation of deforming the figure indicated by the figure information (see FIG. 17).

Therefore, the cutoff frequency of the high-pass filter can be changed by an intuitive operation of changing the figure indicating the extraction band for at least one of the contrast component and the edge component.

Furthermore, the extraction band is visualized and displayed by a figure, so that the user can easily image the extraction band.

Furthermore, the image processing apparatus (imaging device 1, 1A, 1B, information processing device 60, display device 10F) as the embodiment includes a luminance suppressed image generation unit (knee processing unit 34) that generates a luminance suppressed image (SDR image) according to a second dynamic range narrower than a first dynamic range from a captured image obtained by an imaging unit that can obtain a captured image according to the first dynamic range, in which the contrast extraction unit, the edge extraction unit, and the image amplification unit performs, for an image before being input to the luminance suppressed image generation unit as an input image, extraction of the contrast component, extraction of the edge component, and the amplification, the image processing apparatus further including an image superimposing unit (addition unit 47) that superimposes the superimposed image on the luminance suppressed image.

Therefore, corresponding to a case where the output target image such as a through-the-lens image and the like, for example, is the luminance suppressed image (SDR image), for example, it is possible to achieve the image quality improvement and the easiness improvement of in-focus confirmation for the low-luminance image region in the output target image when the dark portion is captured. For confirmation, in a case where the output target image is the luminance suppressed image, the image quality improvement for the low-luminance image region is achieved both by the image quality improvement due to the noise reduction accompanying the superimposition of the edge component and the image quality improvement due to the reproducibility improvement of the low-luminance image region accompanying the superimposition of the contrast component.

Furthermore, in the image processing apparatus as the embodiment, the luminance suppressed image generation unit generates the luminance suppressed image by knee processing.

By the knee processing, the dynamic range conversion for generating the luminance suppressed image can be appropriately performed.

Furthermore, in the image processing apparatus as the embodiment, the image superimposing unit superimposes the superimposed image on the luminance suppressed image displayed as a through-the-lens image.

Therefore, for the through-the-lens image in a case where the dark portion is captured, it is possible to achieve the image quality improvement while achieving the easiness improvement of in-focus confirmation. Therefore, it is suitable in a case where the user manually adjusts the focus of the camera based on the through-the-lens image while capturing the dark portion.

Moreover, the image processing apparatus (imaging device 1A) according to an embodiment further includes: a region detection unit (target region control unit 41A) that detects, from the input image, a low-luminance image region having a luminance value less than a first threshold value and a high-luminance image region having a luminance value equal to or larger than a second threshold value; and a high-luminance contrast extraction unit (contrast extraction unit 48) that obtains a high-luminance contrast image obtained by extracting a contrast component for the high-luminance image region. The image superimposing unit superimposes the superimposed image and the high-luminance contrast image on the luminance suppressed image.

Therefore, for the low-luminance image region, the luminance suppressed image can be corrected using the superimposed image based on the contrast component and the edge component extracted from the low-luminance image region in the input image as the corrected image, and for the high-luminance image region, the luminance suppressed image can be corrected using the high luminance contrast image obtained by extracting the contrast component from the high-luminance image region in the input image as the corrected image.

Therefore, regarding the output target image by the luminance suppressed image, it is possible to achieve the easiness improvement of in-focus confirmation and the image quality improvement for the low-luminance image region, and it is possible to achieve the image quality improvement for the high-luminance image region by improving the reproducibility using the high luminance contrast component.

Furthermore, the image processing apparatus as the embodiment includes a superimposition control unit (control unit 18) that performs control so that the image superimposed state on the luminance suppressed image is switched among a first state in which the superimposed image and the high luminance contrast image are superimposed on the luminance suppressed image, a second state in which only the superimposed image is superimposed on the luminance suppressed image among the superimposed image and the high luminance contrast image, and a third state in which only the high luminance contrast image is superimposed on the luminance suppressed image among the superimposed image and the high luminance contrast image.

Therefore, regarding the correction of the luminance suppressed image, the correction mode can be switched among the first correction mode using both the superimposed image and the high luminance contrast image, the second correction mode using only the superimposed image in the superimposed image and the high luminance contrast image, and the third correction mode using only the high luminance contrast image in the superimposed image and the high luminance contrast image.

Furthermore, the image processing apparatus as the embodiment can be configured as an imaging device including an imaging unit (11) that obtains a captured image.

Therefore, it is possible to realize an imaging device having excellent functionality capable of executing image processing for achieving the image quality improvement while achieving the easiness improvement of in-focus confirmation for an image obtained by capturing a dark portion.

Moreover, the image processing apparatus as the embodiment can be configured as a display device (display device 10F, 10H) including a display unit that displays an image corrected by a superimposed image.

Therefore, it is possible to realize a display device having excellent functionality capable of executing image processing for achieving the image quality improvement while achieving the easiness improvement of in-focus confirmation for an image obtained by capturing a dark portion.

Furthermore, since it is not necessary to provide the imaging device with a configuration for performing image processing for easiness improvement of in-focus confirmation and image quality improvement, the configuration of the imaging device can be simplified and cost can be reduced.

Furthermore, an image processing method according to the embodiment is an image processing method in which a signal processing apparatus performs processing of obtaining a contrast image obtained by extracting a contrast component from an input image based on a captured image and an edge image obtained by extracting an edge component from the input image, performing processing of multiplying the contrast image by a coefficient determined according to a signal value of the edge image to obtain an edge-enhanced contrast image, and obtaining a superimposed image obtained by superimposing the edge-enhanced contrast image on an amplified image of the input image.

According to such an image processing method, it becomes possible to achieve the image processing apparatus as the embodiment described above.

Here, as the embodiment, it is possible to consider a program for causing, for example, a CPU, a digital signal processor (DSP), or a device including the CPU, the DSP, or the like, to execute the processing (at least the processing as the corrected image generation unit 40a) as the correction processing unit 40 described in FIG. 13 and the like.

That is, the program according to the embodiment is a program that can be read by a computer device, and causes the computer device to execute processing of: obtaining a contrast image obtained by extracting a contrast component from an input image based on a captured image and an edge image obtained by extracting an edge component from the input image; multiplying the contrast image by a coefficient determined according to a signal value of the edge image to obtain an edge-enhanced contrast image; and obtaining a superimposed image obtained by superimposing the edge-enhanced contrast image on an amplified image of the input image.

With such a program, the above-described function as the corrected image generation unit 40a can be realized by software processing in a device as an imaging device, an information processing device, a display device, or the like.

The program described above can be recorded in advance in an HDD as a recording medium built in an apparatus such as a computer device, a ROM in a microcomputer having a CPU, or the like.

Alternatively, the program may be temporarily or permanently stored (recorded) in a removable recording medium such as a flexible disk, a compact disc read only memory (CD-ROM), a magneto optical (MO) disk, a digital versatile disc (DVD), a Blu-ray disc (registered trademark), a magnetic disk, a semiconductor memory, or a memory card. Such a removable recording medium may be provided as what is called package software.

Furthermore, such a program can be installed from the removable recording medium into a personal computer or the like, or can be downloaded from a download site via a network such as a LAN or the Internet.

In addition, such a program is suitable for a wide range of provision of the corrected image generation unit 40a of the embodiment. For example, by downloading the program to a personal computer, a portable information processing device, a mobile phone, a game apparatus, a video apparatus, a personal digital assistant (PDA), or the like, the personal computer or the like can be caused to function as an apparatus that achieves processing as the corrected image generation unit 40a and the like of the present disclosure.

Note that the effects described in the present description are merely examples and are not limited, and other effects may be provided.

### 6. Present Technology

The present technology may also have the following configurations.

(1)

An image processing apparatus including:
a contrast extraction unit that obtains a contrast image by extracting a contrast component from an input image based on a captured image;
an edge extraction unit that obtains an edge image by extracting an edge component from the input image;
an edge-enhancement processing unit that obtains an edge-enhanced contrast image by performing processing of multiplying the contrast image by a coefficient determined according to a signal value of the edge image;
an image amplification unit that obtains an amplified image by amplifying the input image; and
a superimposed image generation unit that obtains a superimposed image obtained by superimposing the edge-enhanced contrast image on the amplified image.
   (2)

The image processing apparatus according to the above-described (1) including
a low luminance region detection unit that detects a low-luminance image region, which is a region having a luminance value of a predetermined value or less, from the input image, in which
the contrast extraction unit and the edge extraction unit extract the contrast component and the edge component for the low-luminance image region in the input image.
   (3)

The image processing apparatus according to the above-described (1) or (2), in which
the edge-enhancement processing unit
does not amplify the signal value of the pixel in which the signal value in the edge image is less than a predetermined threshold value in the signal value amplification of the contrast image.
   (4)

The image processing apparatus according to any one of the above-described (1) to (3), in which
the input image is a RGB image.
   (5)

The image processing apparatus according to any one of the above-described (1) to (4), in which
the contrast extraction unit extracts the contrast component by a first high-pass filter that extracts a frequency component of the input image by a first cutoff frequency, and
the edge extraction unit extracts the edge component by a second high-pass filter that extracts a frequency component of the input image by a second cutoff frequency higher in frequency than the first cutoff frequency.
   (6)

The image processing apparatus according to the above-described (5) including
a frequency control unit that performs control to change at least one of the first and second cutoff frequencies in accordance with an operation.
   (7)

The image processing apparatus according to the above-described (6), in which
for at least one of the first and second high-pass filters, figure information indicating a frequency band to be extracted is displayed on the display device, and
the frequency control unit
performs control to change the corresponding cutoff frequency between the first and second cutoff frequencies in accordance with an operation of deforming the figure indicated by the figure information.
   (8)

The image processing apparatus according to any one of the above-described (1) to (7) including
a luminance suppressed image generation unit that generates a luminance suppressed image according to a second dynamic range narrower than a first dynamic range from a captured image obtained by an imaging unit that can obtain a captured image according to the first dynamic range, in which
the contrast extraction unit, the edge extraction unit, and the image amplification unit performs, for an image before being input to the luminance suppressed image generation unit as the input image, extraction of the contrast component, extraction of the edge component, and the amplification,
the image processing apparatus further including an image superimposing unit that superimposes the superimposed image on the luminance suppressed image.
   (9)

The image processing apparatus according to the above-described (8), in which
the luminance suppressed image generation unit generates the luminance suppressed image by knee processing.
   (10)

The image processing apparatus according to the above-described (8) or (9), in which
the image superimposing unit superimposes the superimposed image on the luminance suppressed image displayed as a through-the-lens image.
   (11)

The image processing apparatus according to any one of the above-described (8) to (10) including
a region detection unit that detects, from the input image, a low-luminance image region having a luminance value less than a first threshold value and a high-luminance image region having a luminance value equal to or larger than a second threshold value; and
a high-luminance contrast extraction unit that obtains a high-luminance contrast image obtained by extracting a contrast component for the high-luminance image region, in which
the image superimposing unit
superimposes the superimposed image and the high-luminance contrast image on the luminance suppressed image.
   (12)

The image processing apparatus according to the above-described (11) including
a superimposition control unit that performs control so that an image superimposed state on the luminance suppressed image is switched among a first state in which the superimposed image and the high luminance contrast image are superimposed on the luminance suppressed image, a second state in which only the superimposed image is superimposed on the luminance suppressed image among the superimposed image and the high luminance contrast image, and a third state in which only the high luminance contrast image is superimposed on the luminance suppressed image among the superimposed image and the high luminance contrast image.
   (13)

The image processing apparatus according to any one of the above-described (1) to (12), in which
the image processing apparatus is configured as an imaging device including an imaging unit that obtains the captured image.
   (14)

The image processing apparatus according to any one of the above-described (1) to (12), in which
the image processing apparatus is configured as a display device including a display unit that displays an image corrected by the superimposed image.
   (15)

An image processing method, in which
a signal processing apparatus performs processing of obtaining a contrast image obtained by extracting a contrast component from an input image based on a captured image and an edge image obtained by extracting an edge component from the input image, performing processing of multiplying the contrast image by a coefficient determined according to a signal value of the edge image to obtain an edge-enhanced contrast image, and obtaining a superimposed image obtained by superimposing the edge-enhanced contrast image on an amplified image of the input image.
   (16)

A program that can be read by a computer device, and
causes the computer device to execute processing of: obtaining a contrast image obtained by extracting a contrast component from an input image based on a captured image and an edge image obtained by extracting an edge component from the input image; multiplying the contrast image by a coefficient determined according to a signal value of the edge image to obtain an edge-enhanced contrast image; and obtaining a superimposed image obtained by superimposing the edge-enhanced contrast image on an amplified image of the input image.

### REFERENCE SIGNS LIST

100 Imaging system
1, 1A, 1B, 1C, 1D, 1E, 1G Imaging device
10, 10F, 10H Display device
10a Display screen
11 Imaging unit
12 Preprocessing unit
13, 13C HDR processing unit
13a HDR processing system
14 Resolution conversion unit
15, 15A, 15B, 15D SDR processing unit
16 Communication unit
17 Communication unit
18 Control unit
19 Operation unit
34 Knee processing unit
40, 40A Correction processing unit
40a Corrected image generation unit
41, 41A Target region control unit
42 Contrast extraction unit
43 Edge extraction unit
44 Amplification unit
45 Edge-enhancement processing unit
46 Addition unit
47 Addition unit
48 Contrast extraction unit
49 Addition unit

1. An image processing apparatus comprising:
a contrast extraction unit that obtains a contrast image by extracting a contrast component from an input image based on a captured image;
an edge extraction unit that obtains an edge image by extracting an edge component from the input image;
an edge-enhancement processing unit that obtains an edge-enhanced contrast image by performing processing of multiplying the contrast image by a coefficient determined according to a signal value of the edge image;
an image amplification unit that obtains an amplified image by amplifying the input image; and
a superimposed image generation unit that obtains a superimposed image obtained by superimposing the edge-enhanced contrast image on the amplified image.

2. The image processing apparatus according to claim 1 comprising
a low luminance region detection unit that detects a low-luminance image region, which is a region having a luminance value of a predetermined value or less, from the input image, wherein
the contrast extraction unit and the edge extraction unit extract the contrast component and the edge component for the low-luminance image region in the input image.

3. The image processing apparatus according to claim 1, wherein
the edge-enhancement processing unit
does not amplify the signal value of the pixel in which the signal value in the edge image is less than a predetermined threshold value in the signal value amplification of the contrast image.

4. The image processing apparatus according to claim 1, wherein
the input image is a RGB image.

5. The image processing apparatus according to claim 1, wherein
the contrast extraction unit extracts the contrast component by a first high-pass filter that extracts a frequency component of the input image by a first cutoff frequency, and
the edge extraction unit extracts the edge component by a second high-pass filter that extracts a frequency component of the input image by a second cutoff frequency higher in frequency than the first cutoff frequency.

6. The image processing apparatus according to claim 5 comprising
a frequency control unit that performs control to change at least one of the first and second cutoff frequencies in accordance with an operation.

7. The image processing apparatus according to claim 6, wherein
for at least one of the first and second high-pass filters, figure information indicating a frequency band to be extracted is displayed on the display device, and
the frequency control unit
performs control to change the corresponding cutoff frequency between the first and second cutoff frequencies in accordance with an operation of deforming the figure indicated by the figure information.

8. The image processing apparatus according to claim 1, comprising
a luminance suppressed image generation unit that generates a luminance suppressed image according to a second dynamic range narrower than a first dynamic range from a captured image obtained by an imaging unit that can obtain a captured image according to the first dynamic range, wherein
the contrast extraction unit, the edge extraction unit, and the image amplification unit performs, for an image before being input to the luminance suppressed image generation unit as the input image, extraction of the contrast component, extraction of the edge component, and the amplification,
the image processing apparatus further comprising an image superimposing unit that superimposes the superimposed image on the luminance suppressed image.

9. The image processing apparatus according to claim 8, wherein
the luminance suppressed image generation unit generates the luminance suppressed image by knee processing.

10. The image processing apparatus according to claim 8, wherein
the image superimposing unit superimposes the superimposed image on the luminance suppressed image displayed as a through-the-lens image.

11. The image processing apparatus according to claim 8 comprising:
a region detection unit that detects, from the input image, a low-luminance image region having a luminance value less than a first threshold value and a high-luminance image region having a luminance value equal to or larger than a second threshold value; and
a high-luminance contrast extraction unit that obtains a high-luminance contrast image obtained by extracting a contrast component for the high-luminance image region, wherein
the image superimposing unit
superimposes the superimposed image and the high-luminance contrast image on the luminance suppressed image.

12. The image processing apparatus according to claim 11, comprising
a superimposition control unit that performs control so that an image superimposed state on the luminance suppressed image is switched among a first state in which the superimposed image and the high luminance contrast image are superimposed on the luminance suppressed image, a second state in which only the superimposed image is superimposed on the luminance suppressed image among the superimposed image and the high luminance contrast image, and a third state in which only the high luminance contrast image is superimposed on the luminance suppressed image among the superimposed image and the high luminance contrast image.

13. The image processing apparatus according to claim 1, wherein
the image processing apparatus is configured as an imaging device including an imaging unit that obtains the captured image.

14. The image processing apparatus according to claim 1, wherein
the image processing apparatus is configured as a display device including a display unit that displays an image corrected by the superimposed image.

15. An image processing method, wherein
a signal processing apparatus performs processing of obtaining a contrast image obtained by extracting a contrast component from an input image based on a captured image and an edge image obtained by extracting an edge component from the input image, performing processing of multiplying the contrast image by a coefficient determined according to a signal value of the edge image to obtain an edge-enhanced contrast image, and obtaining a superimposed image obtained by superimposing the edge-enhanced contrast image on an amplified image of the input image.

16. A program that can be read by a computer device, and
causes the computer device to execute processing of obtaining a contrast image obtained by extracting a contrast component from an input image based on a captured image and an edge image obtained by extracting an edge component from the input image, multiplying the contrast image by a coefficient determined according to a signal value of the edge image to obtain an edge-enhanced contrast image, and obtaining a superimposed image obtained by superimposing the edge-enhanced contrast image on an amplified image of the input image.
